(19) United States
(12) Patent Application Publication
(10) Pub. No.: US 2014/0258849 A1
(43) Pub. Date: Sep. 11, 2014

(54) Automatic Alignment of a Multi-Dimensional Layout

(71) Applicant: Google Inc., Mountain View, CA (US)

(72) Inventors: Irene Chung, Mountain View, CA (US); Juan Carlos Miguel Anorga, San Francisco, CA (US); Shimrit Ben-Yair, Sunnyvale, CA (US); John Cassidy, Mountain View, CA (US); Karl Witte Channell, San Francisco, CA (US); Brynn Marie Evans, San Francisco, CA (US); Michael Thomas Leotta, San Francisco, CA (US); Jay Runquist, Menlo Park, CA (US); Jonathan Terleski, Mountain View, CA (US); Ryo Misha Urano, Sunnyvale, CA (US); Olga N. Wichrowska, Mountain View, CA (US)

(73) Assignee: Google Inc., Mountain View, CA (US)

(21) Appl. No.: 13/894,327

(22) Filed: May 14, 2013

Related U.S. Application Data
(60) Provisional application No. 61/773,548, filed on Mar. 6, 2013.

(51) Int. Cl. G06F 17/21

(52) U.S. Cl. CPC G06F 17/212
USPC 715/243

(57) ABSTRACT

A plurality of content items for a content stream is determined by a system. The system estimates size dimensions for the content items, and determines a multidimensional layout by placing the content items into two or more adjacent containers based on the size dimensions. The system determines a difference in size between the two or more adjacent containers and adjusts an aspect of one or more of the content items to substantially equalize a size of the two or more containers.

### CROSS-REFERENCE TO RELATED APPLICATIONS

This application claims the benefit under 35 U.S.C. §119(e) of U.S. Provisional Patent Application No. 61/773,548, entitled “Automatic Alignment of a Multi-Dimensional Layout” filed Mar. 6, 2013, the entire contents of which are incorporated herein by reference.

### BACKGROUND

The present disclosure relates to automatically aligning a multi-dimensional layout.

When displaying information to a user, it can be difficult to align multiple variably sized content elements into a multi-dimensional array (e.g., columns) in such a way that the array elements appear aligned and visually appealing. For example, a given content element may contain more information (e.g., text, pictures, etc.) than an adjacent content element, causing the elements to have different overall sizes. Furthermore, each column of a layout may include multiple content elements having different sizes, which can cause the columns to have different overall heights and appear misaligned. The problem may further be compounded when using a flexible layout, which can adjust the number of columns being displayed, and thus the content contained by the columns, in response to the resizing of the viewport being used to view the layout.

### SUMMARY

According to one innovative aspect of the subject matter being described in this disclosure, a system may determine a plurality of content items for a content stream and estimate size dimensions for the content items. The system may determine a multidimensional layout by placing the content items into two or more adjacent containers based on the size dimensions, determine a difference in size between the two or more adjacent containers, and adjust an aspect of one or more of the content items to substantially equalize a size of the two or more containers.

In general, another innovative aspect of the subject matter described in this disclosure may be embodied in methods that include determining a plurality of content items for a content stream; estimating size dimensions for the content items; determining a multidimensional layout by placing the content items into two or more adjacent containers based on the size dimensions; determining a difference in size between the two or more adjacent containers; and adjusting an aspect of one or more of the content items to substantially equalize a size of the two or more containers.

Other implementations of one or more of these aspects include corresponding systems, apparatus, and computer programs, configured to perform the actions of the methods, encoded on computer storage devices.

These and other implementations may each optionally include one or more of the following features. For instance, the operations may further include that adjusting the aspect of the one or more of the content items includes exchanging two or more of the content items between the two or more adjacent containers; that exchanging two or more of the content items between the two or more adjacent containers includes determining that a rank elasticity measurement for each of the two or more content items meets a predetermined threshold; that adjusting the aspect of the one or of more of the content items includes adjusting a height of the one or more of the content items; that determining a viewport property for a viewport designated to display the plurality of content items in the content stream; determining a number of columns for the multidimensional layout based on the viewport property; that each of the two or more adjacent containers represents a column of the multidimensional layout; rendering the two or more adjacent containers; determining a height for each of the two or more adjacent containers based on the rendering; that each of the two or more adjacent containers represents a column of the multidimensional layout and the determining the difference in size between the two or more adjacent containers includes comparing the height of each of the two or more adjacent containers; and processing an optimized layout to improve placement of a future plurality of content items in a future multidimensional layout.

These implementations are particularly advantageous in a number of respects. For instance, the technology described herein can eliminate the need to hide, crop, or truncate content in order to create alignment between columns of a layout upon resizing of a viewport or the addition of new content. Further, the technology may render stream items in multiple columns on the server and client while minimizing vertical whitespace between them, support fast scaling of stream item widths and popping between multiple columns based on window size, and can render certain candidate items across multiple columns. It should be understood, however, that the above features and advantages are not all-inclusive and many additional features and advantages are contemplated and fall within the scope of the present disclosure. Moreover, it should be noted that the language used in this disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for automatically aligning a multi-dimensional layout.

FIGS. 2A and 2B are block diagrams illustrating an example application server.

FIGS. 3A and 3B are block diagrams illustrating an example client device.

FIG. 4 is a diagram showing interactions between example components of an example front-end rendering engine and an example back-end rendering engine.

FIG. 5 is a flowchart of an example method for automatically determining and optimizing a multi-dimensional layout.

FIG. 6 is a flowchart of an example front-end method for optimizing a predetermined initial layout.

FIG. 7 is a flowchart of an example back-end method for determining an initial layout.

FIG. 8 is a flowchart of an example method for loading new posts into a content stream.

FIG. 9 is a diagram illustrating the optimization of an example initial layout.

FIG. 10 is a diagram illustrating the rearrangement of posts of an example initial layout.

FIG. 11 is a diagram illustrating the promotion of a post to a superpost within an example layout.

FIG. 12 is a diagram illustrating the selection and placement of an example superpost based on candidacy.

FIG. 13 is a diagram illustrating the flexibility of the multicolumn layout engine to selectively determine example layout parameters and content arrangement based on viewport size.

FIG. 14 is a diagram illustrating the flexibility of the multicolumn layout engine to selectively determine example layout parameters and content arrangement based on viewport size.

FIGS. 15A and 15B are graphic representations of an example user interface for viewing new posts loaded real-time into a content stream.

FIG. 16 is a graphic representation of an example user interface containing a content stream having an optimized layout of posts.

### DETAILED DESCRIPTION

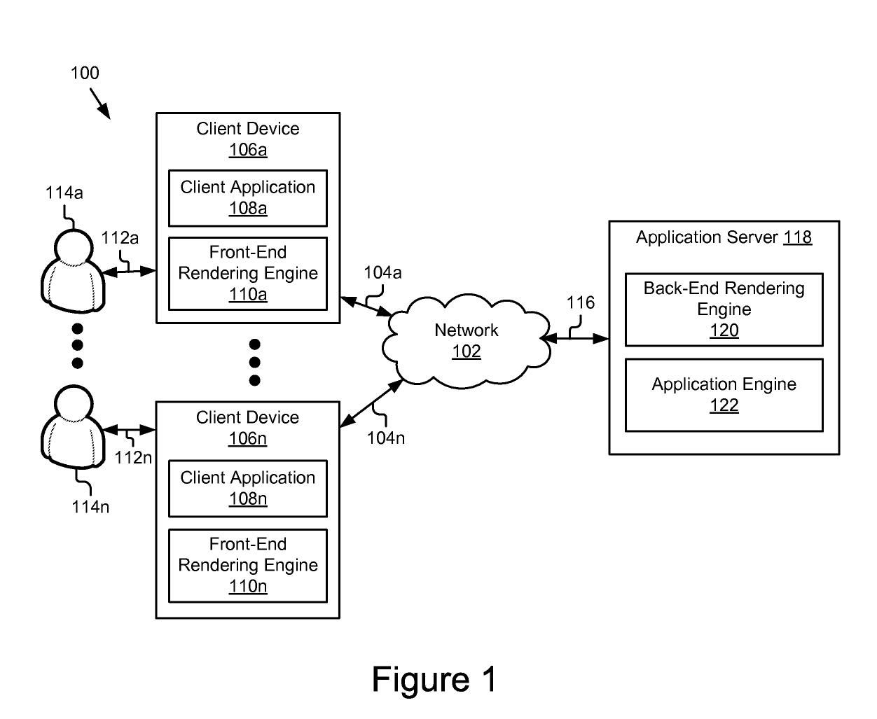

FIG. 1 is a block diagram illustrating an example system 100 for aligning a multi-dimensional layout. In the depicted implementation, the system 100 includes an application server 118 and client devices 106a . . . 106n (also referred to herein individually and collectively as 106) that are accessible by users 114a . . . 114n (also referred to herein individually and collectively as 114). In the depicted implementation, the entities 106a . . . 106n and 118 are electronically communicatively coupled via a network 102. However, the present disclosure is not limited to this configuration and a variety of different system environments and configurations may be employed and are within the scope of the present disclosure. Other implementations may include additional or fewer computing devices, services, and/or networks. For example, other computing devices (e.g., third party servers) may be coupled to the network 102 to provide various services and functionality. Further, while the present disclosure is described above primarily in the context of activities related to social networking, it is applicable to any type of electronic communication within or between entities of a network.

In some implementations, the entities of the system 100 may use a cloud-based architecture where one or more computer functions or routines are performed by remote computing systems and devices at the request of a local computing device. For example, a client device 106 may be a computing device having hardware and/or software resources and may access hardware and/or software resources provided across the network 102 by other computing devices and resources, including, for instance, other client devices 106, the application server 118, or any other entities of the system 100.

The network 102 is a network for interconnecting computing nodes. The network 102 may have any number of configurations or topologies. For example, the network 102 may have a star, token ring, or other known topology or hybrid thereof. The network 102 may include a local area network (LAN), a wide area network (WAN) (e.g., the Internet), and/or any other interconnected data path across which multiple devices may communicate. The network 102 may be coupled to or include a mobile (cellular) network including distributed radio networks and a hub providing a wireless wide area network (WWAN), or other telecommunications networks. In some implementations, the network 102 may include Bluetooth® communication networks for sending and receiving data. The network 102 may transmit data using a variety of different communication protocols including, for example, various Internet layer, transport layer or application layer protocols. For example, the network 102 may transmit data using user datagram protocol (UDP), transmission control protocol (TCP), HTTP, HTTPS, file transfer protocol (FTP), WebSocket (WS), WAP, IMAP, SMTP, POP, SMS protocol, MMS protocol, XMS protocol, or other known protocols.

The client devices 106a . . . 106n are computing devices having data processing and data communication capabilities. In the depicted implementation, the client device 106a is coupled to the network 102 via signal line 104a, and the user 114a's interactions with client device 106a are depicted by line 112a; and the client device 106n is coupled to the network 102 via signal line 104n, and the user 114n's interactions with the client device 106n are depicted by line 112n.

In some implementations, a client device 106 includes a workstation computer, a desktop computer, a laptop computer, a netbook computer, a tablet computer, a smartphone, a set-top box/unit, an Internet Protocol-connected smart TV including a computer processor capable of receiving viewer input, accessing video content on computer networks (e.g., the Internet), and executing software routines to provide enhanced functionality and interactivity to viewers, or the like. In some implementations, the client device 106 can be a handheld wireless computing device which is capable of sending and receiving voice and/or data communications.

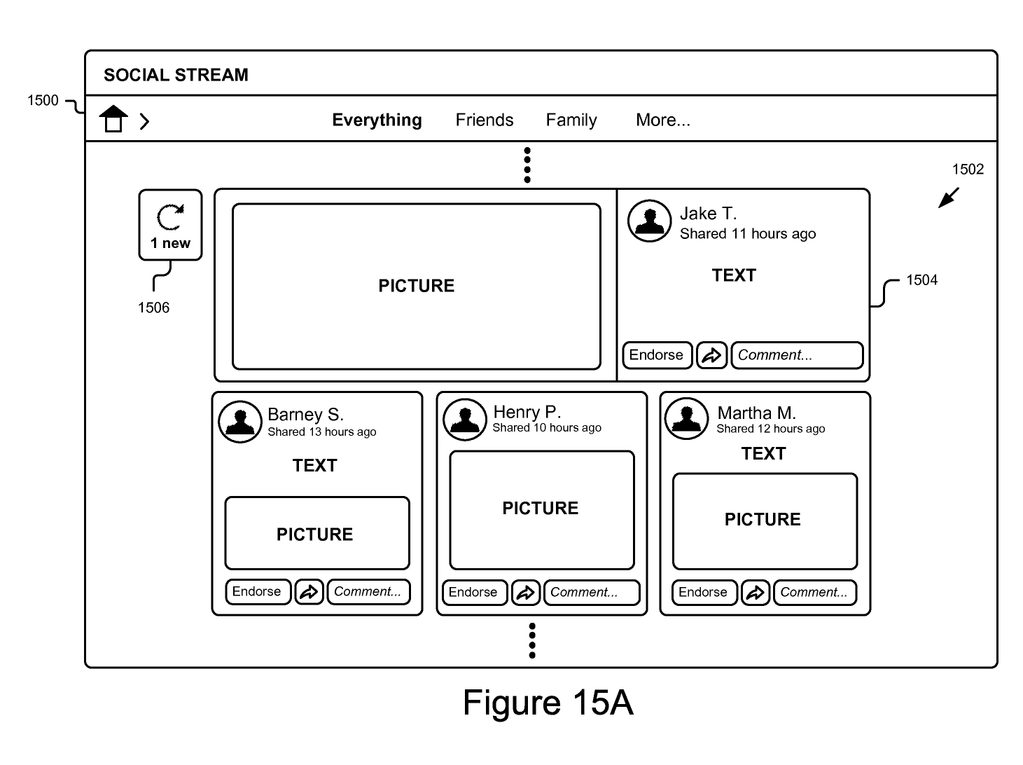

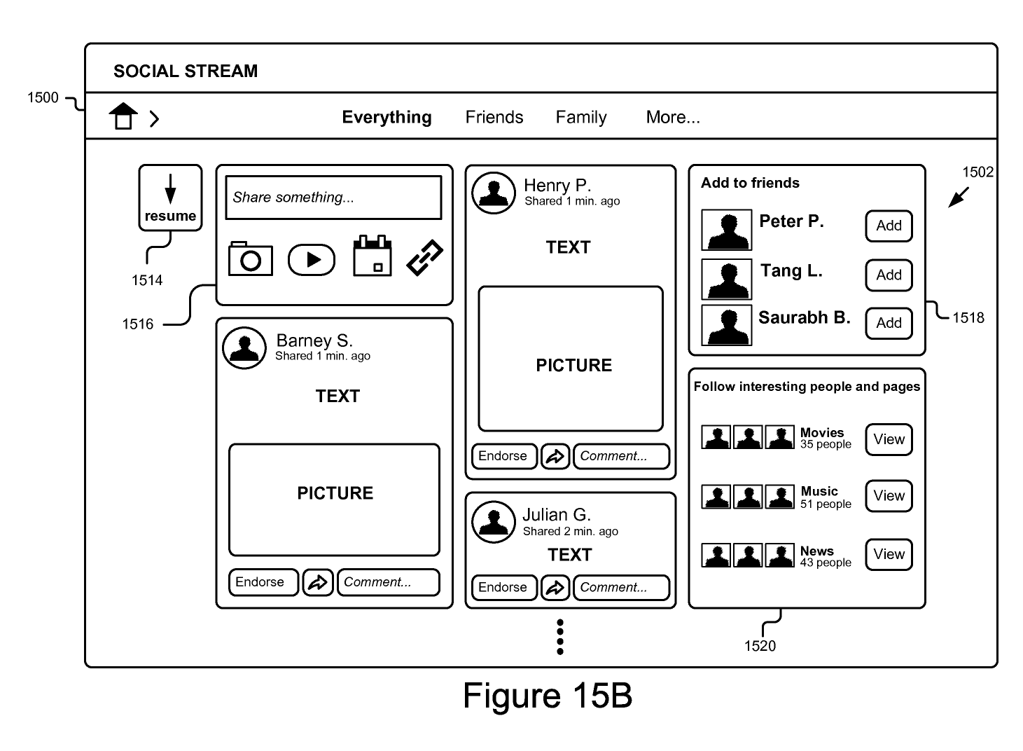

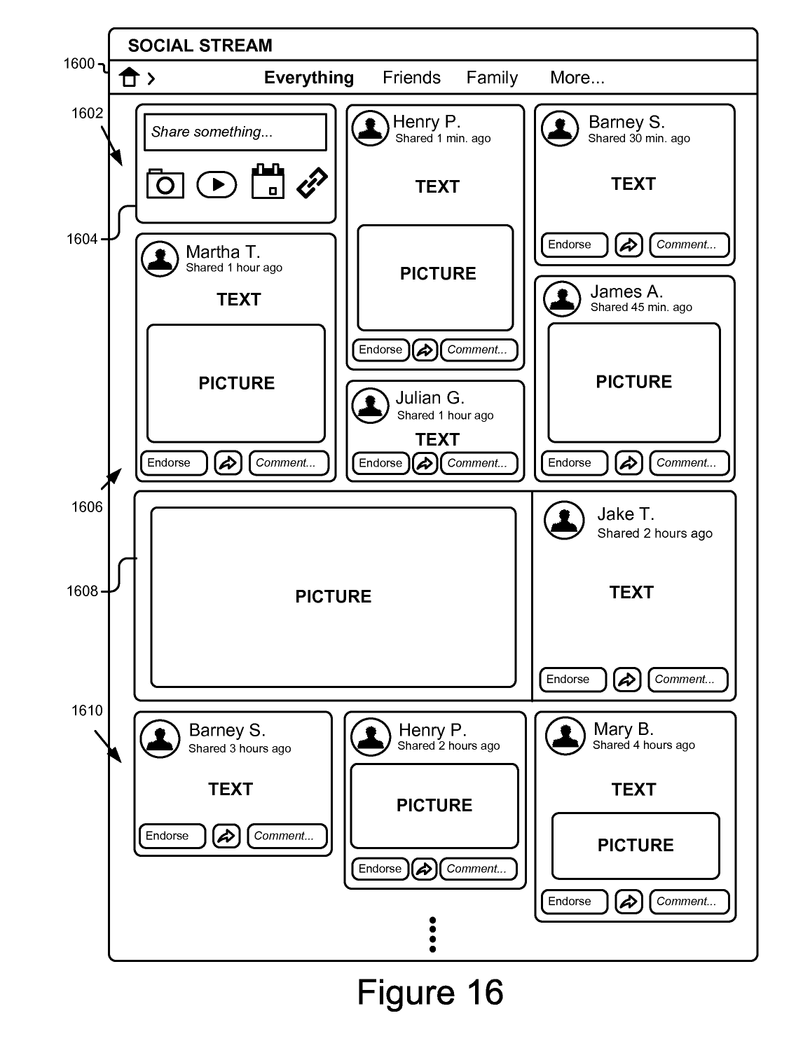

In the depicted implementation, the client devices 106a . . . 106n respectively include client applications 108a . . . 108n (also referred to herein individually and collectively as 108) and front-end rendering engines 110a . . . 110n. The client applications 108a . . . 108n are executable by the client devices 106a . . . 106n to render user interfaces, receive user input, and send information to and receive information from the application server 118 and any other entities of the system 100. The front-end rendering engines 110a . . . 110n (also referred to herein individually and collectively as 110) may be executable by the client devices 106a . . . 106n to receive and/or adjust/optimize the layout of content. In some implementations, the client application 108 may cooperate with the front-end rendering engine 110 to render and display content to the user 114 via a display (not shown). For example, the front-end rendering engine 110 may render and organize the content items (e.g., posts) of a social network content stream into an optimized layout and may instruct the client application 108 (e.g., via APIs of the client application 108) to display the content items (e.g., posts) using the layout. As discussed in further detail below, FIGS. 15A, 15B, and 16 depict a non-limiting examples of user interfaces that may be rendered and displayed by the client application 108 in cooperation with the front-end rendering engine 110, based at least in part on information received from the application server 118 via the network 102.

In some implementations, the front-end rendering engine 110 and/or the client application 108 may receive interface instructions from the application engine 122 or the back-end rendering engine 120 of the application server 118 via the network 102 in the form of a mark-up language (e.g., HTML, XML, etc.), style sheets (e.g., GSS, CSS, XSL, etc.), graphics, and/or scripts (e.g., JavaScript, ActionScript, etc.), and may then interpret the interface instructions and render an interactive Web User Interface (WUI) for display on the client device 106 based thereon. In some implementations, some or all of the interface instructions may be provided by the client application 108 and/or front-end rendering engine 110, while the substantive information may be provided by the application server 118. Other variations are also contemplated and within the scope of this disclosure.

A viewport is a visual area displayable by the client application 108 that includes an interface for a user to view and interact with content. In some implementations, the client application 108 may include a web browser and the viewport may include a window and/or tab of the web browser for displaying content retrieved from memory and/or the network 102, although other configurations are contemplated and possible.

As depicted in FIG. 1, the application server 118 is coupled to the network 102 via signal line 116 for interaction with the other components coupled to the network 102. The application server 118 may include one or more computing devices having one or more processors, and one or more storage devices for storing data or instructions for execution by the one or more processors. For example, a computing device may be a hardware server, a server array or any other computing device, or group of computing devices, having data processing, storing and communication capabilities. A computing device may also be a virtual server (e.g., a virtual machine) implemented via software. For example, the virtual server may operate in a host server environment and access the physical hardware of the host server including, for example, a processor, memory, storage, network interfaces, etc., via an abstraction layer (e.g., a virtual machine manager). Although only one application server 118 is shown; any number of application servers 118 and/or other computing devices may be included in the system 100. Furthermore, it should be understood that any of the entities of the system 100 can be stored in any combination of devices and servers or in one device or server.

In the depicted implementation, the application server 118 includes an application engine 122 and a back-end rendering engine 120. In some implementations, the application engine 122 includes a social network application configured to provide functionality for a social networking service (also referred to as a social network) and the back-end rendering engine 120 receives and organizes information received from the social network application. For instance, the back-end rendering engine 120 may render an initial layout for a set of content stream items (e.g., posts) determined by the application engine 122 and designated to be provided to a given user for display and interaction.

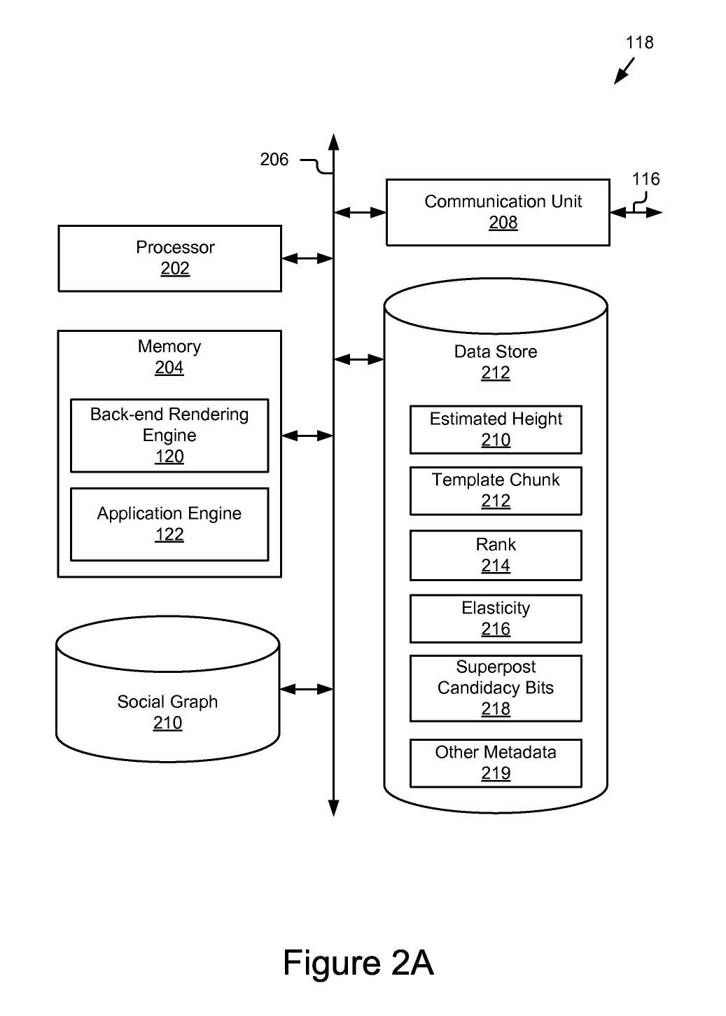

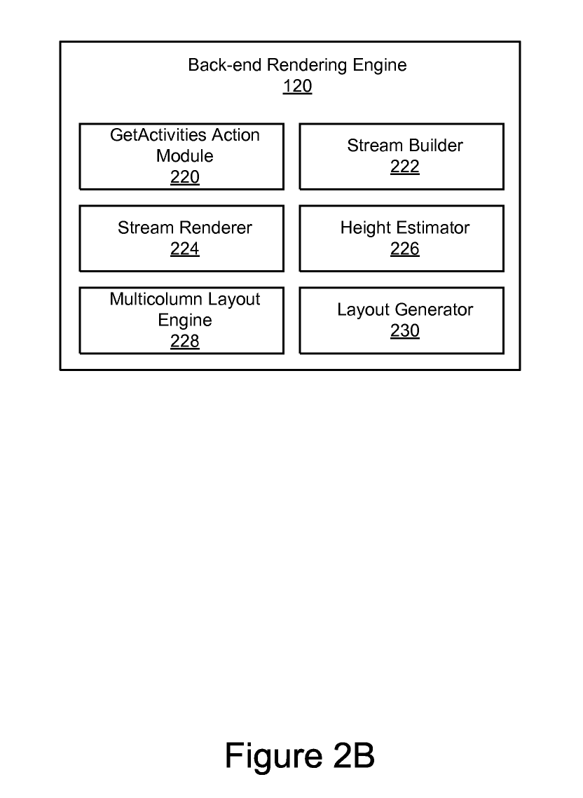

It should be understood that the application engine 122 may include any service that provides a set or stream of content items that are renderable for display to a user, including, for example and not limitation, a news service, an e-commerce website offering a variety of products for sale, a comparison shopping service providing functionality for comparing and purchasing products, a micro-blog stream, a blog service, etc. By way of further example and not limitation, the application engine 122 is applicable to any content service where the content items are displayable in a multi-dimensional array (e.g., in columns and/or rows), etc. Additional structure, acts, and/or functionality of the application engine 122 and the back-end rendering engine 120 are further described below with reference to at least FIGS. 2A and 2B. While only the application server 118 is depicted in FIG. 1 as including a back-end rendering engine 120, it should be understood that this implementation is provided by way of example and that any single entity or any number of entities may include an instance of the back-end rendering engine 120. A content item (e.g., post) may include one or more components (e.g., text, embedded content, images, video, interface elements, etc.) that may be rendered for display to a user. In some implementations, a content item may include a mixin, which includes content calling the user to action (e.g., requesting the user to complete an aspect of the user's profile, notifying the user about unknown or underutilized features and functionality of a system, etc.). It should be understood that while some implementations provided herein are described within the context of posts, it should be understood that these implementations are non-limiting and are applicable to any type and/or form of content item includable in a content stream.

The application engine 122 or another component of the system 100 may require users to register for a user account to access various functionalities and services provided thereby. For example, to register, a credential module included in and operated a given entity of the system 100 (e.g., the application server 118, a third-party server (not shown), etc.) may require a user 114 to provide identifying information, for example, a valid electronic address and password, and the module may test the validity of the electronic address by sending the a confirmation message to the address containing instructions for confirming the account (e.g., selecting a hyperlink to a confirmation webpage operated by the service provider). Once registered, the credential module may require a user seeking access to the service operated by this entity to authenticate by inputting the identifying information in an associated user interface.

FIGS. 2A and 2B are block diagrams of an example application server 118. In the depicted implementation, the application server 118 includes a processor 202, a memory 204, a communication unit 208, a social graph 210, and a data store 212, which are communicatively coupled via a bus 206. The memory 204 is depicted as including the application engine 122 and the back-end rendering engine 120. In various implementations, the application engine 122 and/or the back-end rendering engine 120 may be sets of instructions stored in the memory 204 and executable by the processor 202 for communication with the other components of the application server 118; may be implemented via one or more application specific integrated circuits (ASICs) coupled to the bus 206 for cooperation and communication with the other components of the application server 118; sets of instructions stored in one or more discrete memory devices (e.g., a PROM, FPROM, ROM) that are coupled to the bus 206 for cooperation and communication with the other components of the application server 118; other hardware or software; a combination thereof; etc.

The application server 118 depicted in FIG. 2A is provided by way of example and it should be understood that the application server 118 may take other forms and include additional or fewer components without departing from the scope of the present disclosure. For example, while not shown, in some implementations, the application server 118 may include input and output devices (e.g., a computer display, a keyboard and mouse, etc.), various operating systems, sensors, additional processors, and other physical configurations. Additionally, it should be understood that the computer architecture depicted in FIG. 2A is applicable to the other entities of the system 100 with various modifications. For example, a third party server (not shown) could have the same or a similar architecture as the application server 118 depicted in FIG. 2A, including, for instance, the processor 202, the memory 204, the communication unit 208, and the data store 212 coupled via the bus 206.

The bus 206 can include a conventional communication bus for transferring data between components of a computing device or between computing devices, a network bus system including the network 102 or portions thereof, a processor mesh, a combination thereof, etc. In some implementations, the application engine 122, the back-end rendering engine 120 and its sub-components 220, 222, 224, 226, 228, and 230 (see FIG. 2B), and/or various software operating on the application server 118 (e.g., an operating system) may cooperate and communicate via a software communication mechanism implemented in association with the bus 206. The software communication mechanism can include and/or facilitate, for example, inter-process communication, local function or procedure calls, remote procedure calls, an object bus (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The processor 202 includes an arithmetic logic unit, a microprocessor, a general purpose controller, or some other processor array to perform computations and provide electronic display signals to a display device (not shown). The processor 202 may be coupled to the bus 206 for communication with the other components of the application server 118. The processor 202 may process data signals and may have various computing architectures including a complex instruction set computer (CISC) architecture, a reduced instruction set computer (RISC) architecture, or an architecture implementing a combination of instruction sets. Although only a single processor 202 is shown in FIG. 2A, multiple processors may be included and each processor may include a single processing core or multiple interconnected processing cores. The processor 202 may be capable of supporting the display of images and the capture and transmission of images, perform complex tasks, including various types of feature extraction and sampling, etc.

The memory 204 stores instructions and/or data that may be executed by the processor 202. In the depicted implementation, the memory 204 stores at least the application engine 122 and the back-end rendering engine 120. The memory 204 is also capable of storing other instructions and data, including, for example, an operating system, hardware drivers, other software applications, databases, etc. The memory 204 is coupled to the bus 206 for communication with the processor 202 and the other components of application server 118. The instructions and/or data may include code for performing any and/or all of the techniques described herein. In particular, the memory 204 includes a non-transitory computer-usable (e.g., readable, writeable, etc.) medium, which can be any apparatus or device that can contain, store, communicate, propagate or transport instructions, data, computer programs, software, code, routines, etc., for processing by or in connection with the processor 202. A non-transitory computer-usable storage medium may include any and/or all computer-usable storage media. In some implementations, the memory 204 may include volatile memory, non-volatile memory, or both. For example, the memory 204 may include one or more of a dynamic random access memory (DRAM) device, a static random access memory (SRAM) device, flash memory, a hard disk drive, a floppy disk drive, a CD ROM device, a DVD ROM device, a DVD RAM device, a DVD RW device, a flash memory device, and any other mass storage device known for storing information on a more permanent basis. It should be understood that the memory 204 may be a single device or may include multiple types of devices and configurations.

The communication unit 208 may include devices for communicating with other electronic devices. For example, the communication unit 208 may include wireless network transceivers (e.g., Wi-Fi™, Bluetooth®, cellular), wired network interfaces (e.g., a CAT-type interface), USB, FireWire, or other known interfaces. The communication unit 208 may provide connections to the network 102 and to other entities of the system 100 using standard communication protocols including, for example, those discussed with reference to the network 102. The communication unit 208 may link the processor 202 to the network 102, which may in turn be coupled to other processing systems. In the depicted implementation, the communication unit 208 is coupled to the network 102 via signal line 116 for communication and interaction with the other entities of the system 100.

A social network is any type of social structure where the users are connected by one or more common features. The common features can include any attribute, interest, preference, relation, or interaction attributable to the users. For example, the common features include relationships/connections, e.g., professional and academic attributes and interests, friendships, familial ties, etc. The common features can also include explicitly-defined relationships and relationships implied by social connections with other online users and entities. The common features can be provided by one or more social networking systems, including, for example, the application engine 122. These common features, which may be stored as profile information for the users, can be mapped by the application engine 122 to connect the users.

A user's social graph may include social graph connection information describing connections between that user and the other users of the social network; what common features (e.g., attributes, interests, social network activity, relationships, etc.) connect that user to other users; any groups/sets formed by that user and/or the application engine 122 to categorize or group his or her connections on the social network; the strength of the connections (e.g., affinity) between the user and other users, which can be calculated based on, for example, the degree or degrees (e.g., 1st, 2nd, 3rd, 4th, etc.) of separation between the user and other users, who, if any, the connecting/interstitial users are; the amount or type of interactions between the users, etc.; etc. For instance, the application engine 122 and/or a user (e.g., via an associated user interface), may define groups for users who are work friends, school friends, networking contacts, clients, etc., and user's social graph may include data reflecting what groups these users belong to. Together, the social graphs of the users form a collective social graph 210 that reflects a mapping of all of the users of the social network and how they are related.

In some implementations, the information stored by the social graph 210 may be stored in the memory 204 or a data store of the application server 118, or may be included in a memory, computing device and/or storage system distinct from but accessible by the application server 118. In various implementations, the social graph 210 stores records, files, objects, data, etc., in cooperation with a file system executable by the processor 202. The social graph 210 may additionally or alternatively include a database management system (DBMS) executable by the processor 202 to manage a collection of records, files, objects, etc. For example, the database could be a structured query language (SQL) and/or a NoSQL DBMS storing data that can be manipulated using programmatic operations (e.g., queries and statements) by the application engine 122, the back-end rendering engine 120, and the other entities of the system 100.

The data store 212 is an information source capable of storing and providing access to data to the various entities coupled to the network 102. In the depicted implementation, the data store 212 is coupled for communication with the components 202, 204, 208, and 210 of the server 118 via the bus 206, and coupled, via the processor 202, for communication with the components 220, 222, 224, 226, 228 and 230 of the back-end rendering engine 120 (see FIG. 2B) and the back-end rendering engine 120 itself. In some implementations, the data store 212 includes a database management system (DBMS) operable on the application server 118 or another computing device and storable in the memory thereof. For example, the DBMS could be a structured query language (SQL) DBMS and the components 120, 220, 222, 224, 226, 228 and 230 (see FIG. 2B) are configured to manipulate, e.g., store, query, update, and/or delete, data stored in the data store 212 using programmatic operations (e.g., SQL queries and statements).

The data stored by the data store 212 may include information generated, received, or sent by the back-end rendering engine 120 and/or its sub components 220, 222, 224, 226, 228 and 230 (see FIG. 2B); the application server 118; the font-end rendering engine 110 and/or its sub components, etc. In some implementations, the data store 212 may store layout objects including metadata for the content items (e.g., posts) that are processed by the back-end rendering engine 120 including, for example but not limitation, estimated height 210, template chunks 212, ranking 214, elasticity of ranking 216, superpost candidacy bits 218, and other metadata 219 (e.g., unique item id's, fixed position indicators, etc.), etc. Additionally or alternatively, the data store 212 may store the initial layouts determined by the back-end rendering engine 120, the optimized layouts processed by the front-end rendering engine 110, machine learning data for improving height estimates and layout algorithms, etc. In some instances, one or more of the components 220, 222, 224, 226, 228, 230, 108, 110, 120, and/or 122 may use the data stored in and retrievable from the data store 212 to perform their respective functionalities as discussed elsewhere herein.

The back-end rendering engine 120 is software, code, logic, or routines for determining an initial layout for a set of content items (e.g., posts). In some implementations, the back-end rendering engine 120 may be configured to determine properties for the content items (e.g., height estimates, superpost candidacy, etc.), determine and/or promote superpost candidates, provide initial layouts to the front-end rendering engine 110 for further processing, process past layouts and optimizations thereof to improve future layouts, etc. An initial layout determined by the back-end rendering engine may be flexible and may be configured to adapt to changes to the viewport, including, for example but not limitation, a window size change.

As depicted in FIG. 2B, the back-end rendering engine 120 includes a getactivities action module 220, a stream builder 222, a stream renderer 224, a height estimator 226, a multicolumn layout engine 228, and a layout generator 230, which cooperatively provide the functionality of the back-end rendering engine 120. However, the arrangement illustrated in FIG. 2B is provided by way of example, and it should be understood that other arrangements are possible. For example, an alternative arrangement could combine the functionality of one or more of the components 220, 222, 224, 226, 228 and/or 230 into a single component, integrate the back-end rendering engine 120 into other software applications (e.g., the application engine 122), or vice versa, or further divide the modules into separate additional cooperative components.

In the depicted implementation, the components 220, 222, 224, 226, 228 and/or 230 are electronically communicatively coupled for cooperation and communication with each other, the application engine 122, the processor 202, the memory 204, the communication unit 208, the social graph 210, and/or the data store 212. These components 220, 220, 224, 226, 228 and 230 are also coupled for communication with the other entities (e.g., client devices 106, the application server 118, etc.) of the system 100 via the network 102.

In some implementations, the application server 118, the back-end rendering engine 120, the getactivities action module 220, the stream builder 222, the stream renderer 224, the height estimator 226, the multicolumn layout engine 228, and the layout generator 230 are sets of instructions executable by the processor 202, or logic included in one or more customized processors, to provide their respective functionalities. In some implementations, the application server 118, the back-end rendering engine 120, the getactivities action module 220, the stream builder 222, the stream renderer 224, the height estimator 226, the multicolumn layout engine 228, and/or the layout generator 230 are stored in the memory 204 of the application server 118 and are accessible and executable by the processor 202 to provide their respective functionalities. In any of these implementations, the application server 118, the back-end rendering engine 120, the getactivities action module 220, the stream builder 222, the stream renderer 224, the height estimator 226, the multicolumn layout engine 228, and/or the layout generator 230 are adapted for cooperation and communication with the processor 202 and other components of the application server 118.

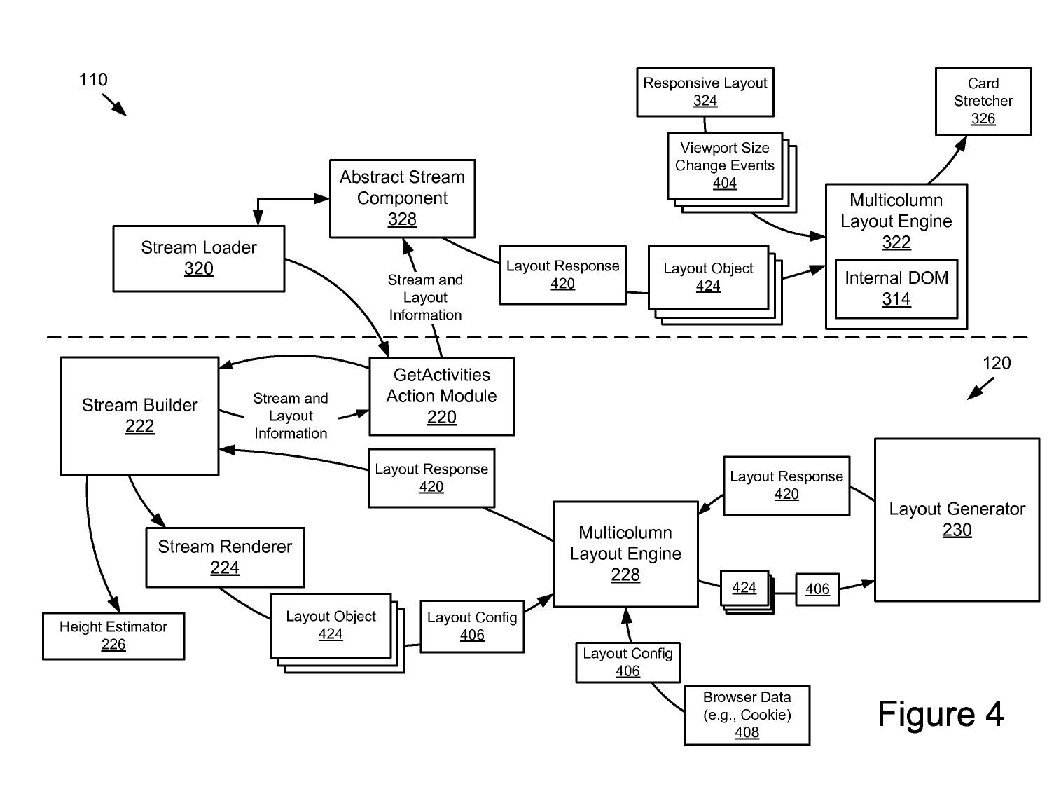

Additional structure, acts, and/or functionality of the back-end rendering engine 120 including the getactivities action module 220, the stream builder 222, the stream renderer 224, the height estimator 226, the multicolumn layout engine 228, and the layout generator 230 are further discussed below with reference to at least FIG. 4.

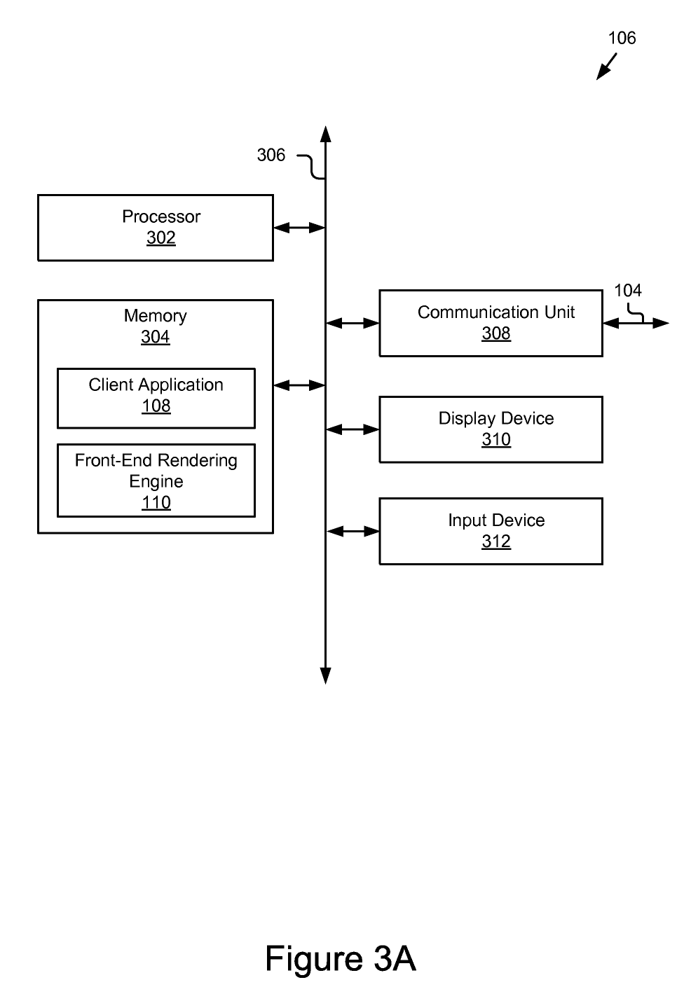

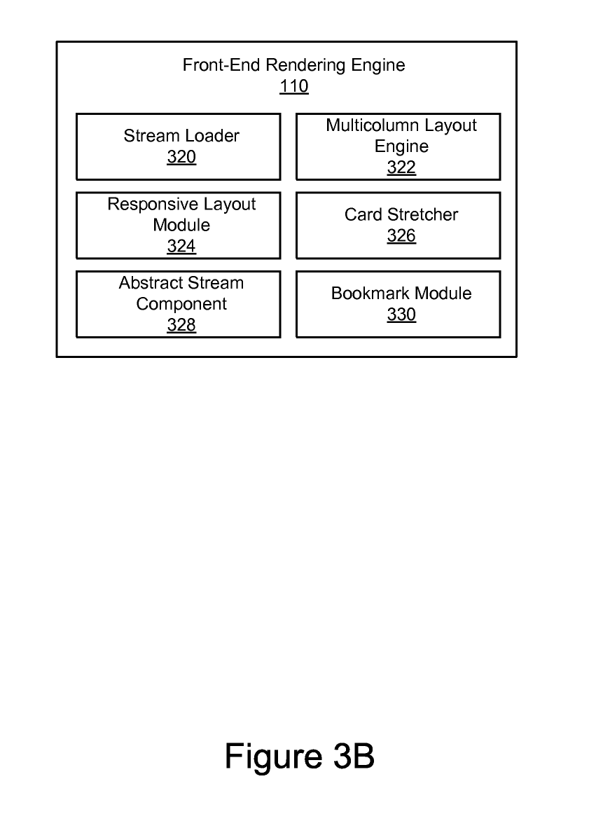

FIG. 3A is a block diagram of an example client device 106. As depicted, the client device 106 may include a processor 302, memory 304, communication unit 308, display device 310, and/or input device 312, which are communicatively coupled by a communications bus 306. However, it should be understood that the client device 106 is not limited to such and may also include other elements, including, for example but not limitation, a power source, a graphics processor; a high-resolution touchscreen; a physical keyboard; forward and rear facing cameras; sensors like accelerometers and/or gyroscopes; a GPS receiver; a Bluetooth® module; memory storing applicable firmware; and various physical connection interfaces (e.g., USB, HDMI, headset jack, etc.); etc.

The processor 302 may execute software instructions by performing various input/output, logical, and/or mathematical operations. The processor 302 have various computing architectures to process data signals including, for example, a complex instruction set computer (CISC) architecture, a reduced instruction set computer (RISC) architecture, and/or an architecture implementing a combination of instruction sets. The processor 302 may be physical and/or virtual, and may include a single core or plurality of processing units and/or cores.

The memory 304 may store and provide access to data to the other components of the client device 106. In some implementations, the memory 304 may store instructions and/or data that may be executed by the processor 302. For example, as depicted, the memory 304 may store the client application 108 and/or front-end rendering engine 110. The memory 304 is also capable of storing other instructions and data, including, for example, an operating system, hardware drivers, other software applications, data, etc. The memory 304 may be coupled to the bus 306 for communication with the processor 302 and the other components of the client device 106.

The communication unit 308 may include one or more interface devices (I/F) for wired and/or wireless connectivity with the network 102 and/or other devices. In some implementations, the communication unit 308 may include transceivers for sending and receiving wireless signals. For example, the communication unit 308 may include radio transceivers (4G, 3G, 2G, etc.) for cellular communication and radio transceivers for Wi-Fi™ and close-proximity (e.g., Bluetooth®, NFC, etc.) connectivity. For instance, the communication unit 308 may connect to and send/receive data via a mobile network of the network 102, a public IP network of the network 102, a private IP network of the network 102, etc. In some implementations, the communication unit 308 may include ports for wired connectivity with other devices. For example, the communication unit 308 may include a CAT-5 interface, USB interface, etc. In the depicted implementation, the communication unit 308 is coupled to the network 102 via signal line 104 for communication and interaction with the other entities of the system 100.

The display device 310 may display electronic images and data output by the client device 108 for presentation to a user 114. The display device 310 may include any conventional display device, monitor or screen, including, for example, an organic light-emitting diode (OLED) display, a liquid crystal display (LCD), etc. In some implementations, the display device 310 may be a touch-screen display capable of receiving input from one or more fingers of a user 114. For example, the display device 310 may be a capacitive touch-screen display capable of detecting and interpreting multiple points of contact with the display surface. In some implementations, the client device 106 may include a graphics adapter (not shown) for rendering and outputting the images and data for presentation on display device 310. The graphics adapter (not shown) may be a separate processing device including a separate processor and memory (not shown) or may be integrated with the processor 302 and memory 304.

The input device 312 may include any device for inputting information into the client device 106. In some implementations, the input device 312 may include one or more peripheral devices. For example, the input device 312 may include a keyboard (e.g., a QWERTY keyboard), a pointing device (e.g., a mouse or touchpad), microphone, an image/video capture device (e.g., camera), etc. In some implementations, the input device 312 may include a touch-screen display capable of receiving input from the one or more fingers of the user 114. For instance, the functionality of the input device 312 and the display device 310 may be integrated, and a user 114 of the client device 106 may interact with the client device 106 by contacting a surface of the display device 310 using one or more fingers. In this example, the user 114 could interact with an emulated (e.g., virtual or soft) keyboard displayed on the touch-screen display device 310 by using fingers to contacting the display in the keyboard regions.

As depicted in FIG. 3B, the front-end rendering engine 110 may include a stream loader 320, a multicolumn layout engine 322, a responsive layout module 324, a card stretcher 326, an abstract stream component 328, and a bookmark module 330. The components 320, 322, 324, 326, 328, and/or 330 may be communicatively coupled by the bus 306 and/or the processor 302 to one another and/or the other components 304, 308, 310, and 312 of the client device 106. In some implementations, one or more of the components 320, 322, 324, 326, 328, and/or 330 are sets of instructions executable by the processor 302 to provide their functionality. In some implementations, one or more of the components 320, 322, 324, 326, 328, and/or 330 are stored in the memory 304 of the client device 106 and are accessible and executable by the processor 302 to provide their functionality. In any of the foregoing implementations, these components 320, 322, 324, 326, 328, and/or 330 may be adapted for cooperation and communication with the processor 302 and other components of the client device 106.

FIG. 4 is a diagram showing interactions between example components of an example front-end rendering engine 110 and an example back-end rendering engine 120. As discussed above with reference to at least FIGS. 2B and 3B, and as depicted in FIG. 4, the front-end (e.g., client-side) rendering engine 110 and the back-end (e.g., server-side) rendering engine 120 each include various components for performing various acts, algorithms, and/or functionality, although it should be understood that other configurations are possible, including, for example, moving some or all of components (or acts, algorithms, and/or functionality thereof) of the front end rendering engine 110 to the back-end rendering engine 120, and vice versa, and/or combining various components of the front end rendering engine 110 and the back-end rendering engine 120 or dividing them into further discrete elements.

The back-end rendering engine 120 may be configured to retrieve a set of content items (e.g., posts), organize the set of content items into an initial layout, and send the set of content items and corresponding layout to the front-end rendering engine 110 for rendering and display to the user. The front-end rendering engine 110 may receive the set of items (e.g., posts) and the initial layout and further optimize and/or reconfigure the initial layout for display to the user. For each item (e.g., post) in the initial layout, the back-end rendering engine 110 may process metadata that characterizes that content item, including, for example, but not limitation, rank, rank elasticity, a superpost candidacy indicator (bit), a droppable indicator (bit), a measure of content item quality, a superpost quality multiplier, a repulsion measurement, a template chunk, a height estimate, a fixed position indicator, a unique item id, etc., and store the processed metadata for quick retrieval and/or use by one or more components of the back-end rendering engine 120 for performing their acts and/or functionalities thereon. The metadata for the content items (e.g., posts) may be stored and/or passed between the components of the back-end rendering engine 110 in a layout object 424.

A content item's (e.g., post's) rank may indicate that item's perceived value to the user in relation to other items. The rank may be pre-determined based on the item's content, user affinity, other social graph features, other signals, etc. The rank's elasticity may indicate how far a given content item may deviate from a given rank or score, thus may be used to determine how far a content item can be moved relative to the other items being displayed. For example, the front-end rendering engine 110 may advantageously use the elasticity measurement to determine if items (e.g., posts) may be re-arranged and how far they may be removed from their current position during optimization of the layout for display. The superpost candidacy bit may indicate whether the content item can be promoted/made into a superpost (e.g., span multiple adjacent containers). The droppable bit may indicate whether the content item can be dropped from being displayed by the front-end rendering engine. For instance, the front-end rendering engine 110 may preserve and display all items (e.g., posts) included in an initial layout by the back-end rendering engine 120 unless a droppable bit is included for a given item. The measure of content item quality may indicate the quality of the contents of the content item (e.g., text or image quality, etc.), which can be used to determine whether the content item may be scaled in size. The superpost quality multiplier may indicate the quality of the contents of a superpost, which may be used to determine its perceived value, whether it can be scaled, and/or whether the content item should be promoted to a superpost. The measure of repulsion between certain types of items (e.g., posts) may indicate the minimum and/or maximum distance that should be maintained between the items. The template chunk may include instructions (e.g., markup language) for processing, defining, and presenting the content item. The height estimate for the content item may be computed by the back-end rendering engine 120 as discussed elsewhere herein. The fixed position indicator may indicate a fixed position for a content item in the initial layout. For instance, the given content item may be configured to always appear at the “top left” position or “top right” position of an initial layout, and the fixed position indicator may identify this requirement. The unique item id may be used to uniquely identify each of the content items (e.g., posts) in the initial layout. The layout object 424 can be used by the back-end rendering engine 120 and/or front-end rendering engine 110 to determine whether and how to render, adjust, and/or optimize the layout of the content items.

The front-end rendering engine 110 may rely on the back-end rendering engine 120 to compute the initial layout for the content items (e.g., posts). For instance, a layout response 420 including a representation of the (initial) layout may be provided by from the back-end rendering engine 120 to the front-end rendering engine 110, and the front-end rendering engine 110 may optimize the layout by rearranging content items (e.g., posts) within the layout and/or adjust sizes of the items once their actual sizes have been rendered. This is advantageous as it can reduce the complexity of the system overall by eliminating duplicative functionality and/or structure. However, implementations are possible and encompassed by this disclosure where the front-end rendering engine 110 includes some or all of the layout operations, structure, and functionality discussed above with reference to the back-end rendering engine 120.

In some implementations, the front-end rendering engine 110 may determine the number of adjacent containers (e.g., columns) that should be used/activated in the layout based on the size of the viewport being used to view the content items and may trigger the back-end rendering engine 120 to re-determine the initial layout for the set of content items in response to a trigger event if a predetermined threshold has been met. The front-end rendering engine 110 may also log the position on the screen that each content item is rendered at (e.g., the coordinates of the top left corner of the post) and provide this information to the back-end rendering engine 120 for processing/learning.

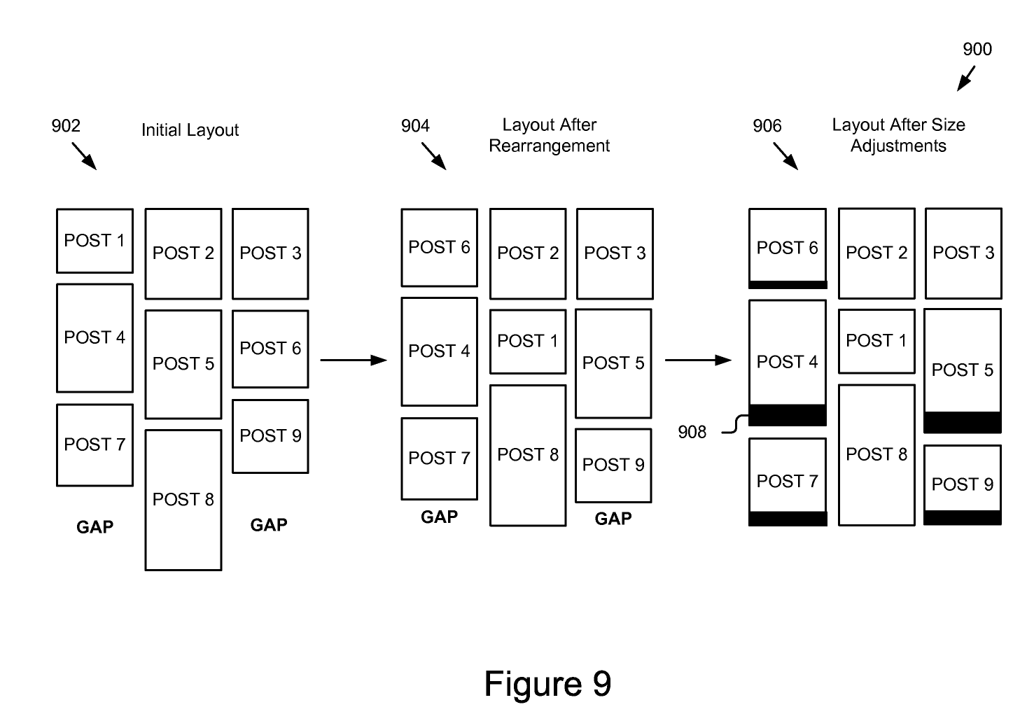

The initial layout provided by the back-end rending engine 120 may be determined by the layout generator 230 in cooperation with the other components of the back-end rendering engine 120 including, for example and not limitation, the multicolumn layout engine 228, the stream renderer 224, the stream builder 222, the height estimator 226, and/or the getactivities action module 220. The layout generator 230, in conjunction with these components, may determine an initial layout that organizes a set of content items into a multi-dimensional (e.g., two dimensional) array of containers according to one or more criteria. In some implementations, the array may include a series of columns or rows. For example, in a portrait orientation the content items may be organized in adjacently situated columns and in a landscape orientation the content items may be organized in adjacently situated rows. The criteria may include, but are not limited to, their estimated size (e.g., height), size range, rank, measure of elasticity, etc. A non-limiting example of an initial layout is depicted in FIG. 9 as 902, which is described in further detail below.

The layout generator 230 may receive as input a layout object 424 that represents and includes metadata for a set of content items to be displayed to a user, and a layout config 406 (e.g., viewport data specifying characteristics of the viewport like its size) and the layout generator 230 may then, based on the input, compute a layout for the layout objects 424, and return a layout response 420 that includes a representation of the computed layout. In some implementations, the layout generator 230 may compute the layout in cooperation with the multicolumn layout engine 228. For example, the layout generator 230 may manage the operations of the multicolumn layout engine 228 via application programming interfaces (APIs) provided by the multicolumn layout engine 228.

The layout generator 230 may be configured to determine whether a given layout object is a superpost candidate based on one or more criteria, including, but not limited to a candidacy bit. Superposts include stream content items that take up more than one container (e.g., column) of the layout area. In some implementations, the superpost may span all visible adjacent containers (e.g., columns) of the layout. The candidacy bit may be provided to the layout generator 230 by the stream builder 222 (e.g., via the stream renderer 224 and the multicolumn layout engine 228). The stream builder 222 may determine the candidacy bit based on a content item's predetermined rank, whether the object contains an embedded image, whether the image properties (e.g., size, aspect ratio, resolution, etc.) meet certain parameters, whether it is not a self-post, whether it is not a re-shared content item, etc. In some implementations, the stream builder 222 may change the superpost candidacy bit over time. For instance, if an attribute of the content item, including, for example, the content item's rank (e.g., quality score) changes, the back-end rendering engine 120 may adjust the candidacy accordingly to promote the content item (e.g., post) as a superpost candidate or demote it from being a superpost candidate.

For example and not limitation, to qualify as a superpost candidate, the stream builder 222 may be configured to require the content item to have a rank that meets or exceeds a certain threshold, to include an embedded photograph that is greater than or equal to 1260 pixels (pxs) wide (so the photograph can be rendered at a higher resolution than smaller non-superpost objects) and has an aspect ratio ranging from 1:2 to 3:4 (height:width) (so the photograph does not have to be cropped), to not be produced by the user designated to receive the content item, to not be reshared by other users with the user designated to receive it, etc. In some cases, even if a content item includes a photograph with an aspect ratio that falls outside of a desired range (e.g., less than 1:2), the back-end rendering engine 120 may still determine it to be a superpost candidate (e.g., if the content item has a high enough rank to qualify). For photographs fall outside of the desired range, the front-end rendering engine 110 can make adjustments to the corresponding content items so a proper size criteria is met (e.g., by placing gray, black, etc. bars around the photographs).

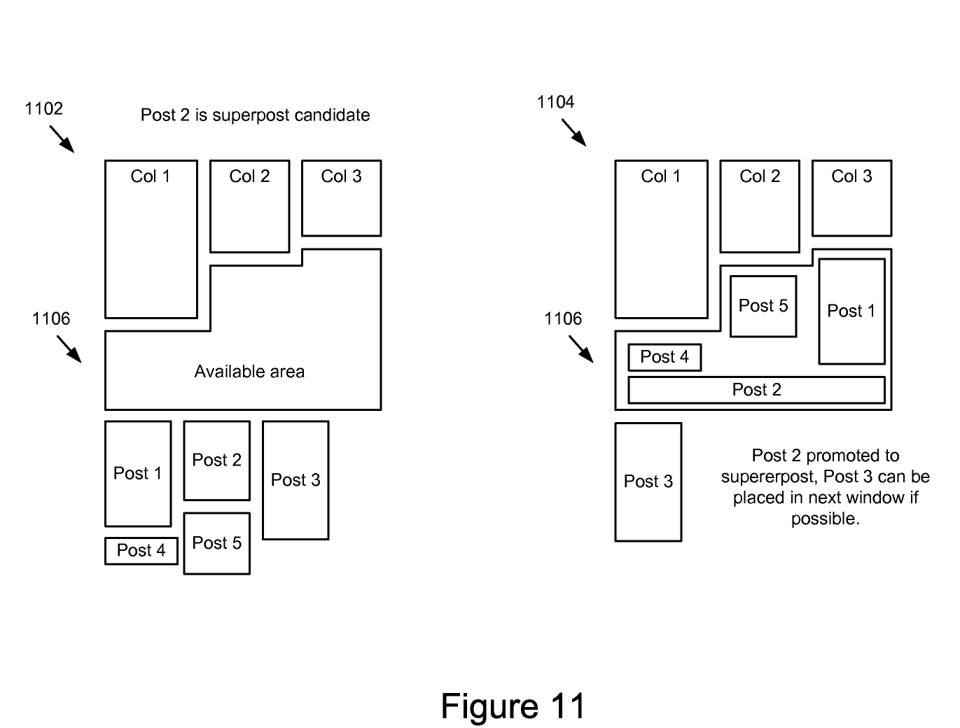

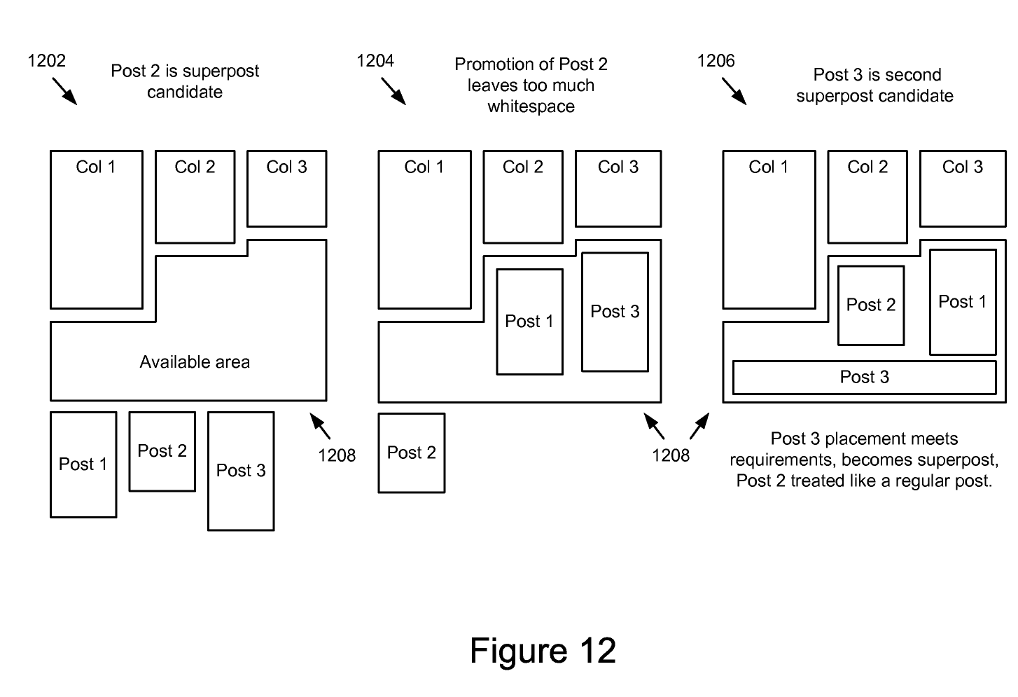

By way of further example and not limitation, FIG. 11 is a diagram illustrating the promotion of a post to a superpost within an example layout. In particular, FIG. 11 shows before 1102 and after 1104 phases of the layout, which includes an area 1106 that the posts, including a superpost (Post 2), may be placed in. In the after phase 1104, Post 2 is promoted as a superpost and spans all three columns and Post 4, 5, and 1 are placed in the columns in which they fit best (e.g., based on their estimated height). FIG. 12 is a diagram illustrating the selection and placement of a superpost based on candidacy. In the first phase 1202, a set of posts (Posts 1, 2, and 3) are determined for placement in the available area 1208. In the second phase 1204, the posts are placed as shown but there is insufficient room for Post 2 to fit as a superpost or a standard post. In the third phase 1206, Post 3 is promoted to a superpost instead of Post 2 so all the posts may fit into the available area 1208. The overall height of posts in phases 1104 and 1206 may be later optimized on the front-end to remove any gaps that may exist between them so the spacing between all of the items of the layout 1104 may be consistent.

The layout generator 230 may decide whether to promote a given content item to a superpost based on its candidacy bit. In some implementations, the candidacy bit for a given object (e.g., post) could become a score multiplier indicating how good the object would be if it was converted to a superpost. The layout generator 230 may be configured to convert/promote every superpost candidate to a superpost or configured to be selective and only select certain superpost candidates to be superposts. For instance, the layout generator 230 may convert superpost candidates based on one or more criteria including, for example but not limitation, the size and/or type of the user's viewport (e.g., window size, user agent, etc.), the nature of the adjacent content in the layout, the amount of whitespace the superpost would create in the layout, the overall visual appeal a resulting layout would have due to a superpost, a limitation on the number of superposts within a layout (e.g. must be at least two rows between superposts, only one superpost per row, etc.), the size and/or content limitations of the viewport, etc. In some implementations, the layout generator 230 may promote a superpost candidate for a first user and not promote the superpost candidate for a second user based on one or more user-related attributes, including for example but not limitation, the users' viewport specifications (e.g., screen and/or window size, user agent, bandwidth, etc.), profile, social graph, content preferences, etc.

In some implementations, the layout generator 230 may be configured to independently determine whether to convert/promote a superpost candidate or may be configured to automatically convert every superpost candidate that has been nominated (e.g., has a candidacy bit). In various implementations, another component of the back-end rendering engine 120, including, for example, the stream builder 222, the stream renderer 224, the multicolumn layout engine 228, etc., may specify whether promotion of a superpost candidate to a superpost is required by specifying and passing a constructor parameter, object, subclass, etc. to the layout generator 230.

In some implementations, the layout generator 230 may cooperate with the multicolumn layout engine 228 to place the superposts in the initial layout. In some implementations, the layout generator 230 may receive the layout object 424 and the layout config 406 from the multicolumn layout engine 228 and the layout generator 230 may further manipulate the layout (e.g., via APIs of the multicolumn layout engine 228) to promote the superposts (e.g., based on the metadata included in the layout object 424).

The multicolumn layout engine 228 may be configured to build and populate an initial layout for the set of content items (e.g., posts) based on size (e.g., height, width, etc.) estimates for the content items, which may be provided in the layout object received from the stream builder 222. The stream builder 222 may interact with the application engine 122 to receive a set of content items and then cooperate with the height estimator 226 to estimate the size of each content item. In some implementations, the stream builder 222 may be configured to determine metadata associated with the set of content items, including, for example, rank, elasticity, fixed position indicators, unique item id's, superpost candidacy bits, etc., as discussed elsewhere herein. The stream builder 222 may create a serialized structured data (e.g., protocol buffer, XML, etc.) based on the set of content items and/or the metadata and provide the serialized structured data to the stream renderer 224 and/or the multicolumn layout engine 228 for use thereby.

The stream renderer 224 may be configured to render template information for the set of content items (e.g., posts) for use by the front-end rendering engine 110 when rendering the set of content items for display. In some implementations, the stream renderer 224 may determine template chunks (e.g., blocks of HTML) for the set of content items. The template chunks may include general layout information (e.g., the base container elements) for each of the content items (e.g., posts) that may be further manipulated by the multicolumn layout engine 228 as discussed elsewhere herein. The stream renderer 224 may include the template chunks in the layout object 424 and send the layout object 424 along to the multicolumn layout engine 228 for use when processing the initial layout.

In some implementations, the layout generator 230 may direct the processing of the initial layout by the multicolumn layout engine 228 via APIs. To reduce the amount of optimization (e.g., rearrangement, adjustments, etc.) that may need to be performed by the front-end rendering engine 110 when rendering the initial layout for display, the multicolumn layout engine 228 may place each of the content items in the initial layout based on a size (e.g., height, width, etc.) estimate of that content item. The multicolumn layout engine 228 may cooperate with the stream renderer 224, the stream builder 222, and/or height estimator 226 to receive these estimates. In some implementations, the stream builder 222 determines the set of content items and then cooperates with the height estimator 226 to calculate an estimate of the height of each of the content items. The stream renderer 224 then provides the size estimate information to the multicolumn layout engine 228 for use thereby. This is advantageous as it can reduce the time and effort needed to optimize the layout when rendering it on the front-end for display.

In some implementations, the height estimator 226 may calculate a size dimension (e.g., the height, width) of a content item (e.g., post) based on one or more of the size dimension of the item's contents, extra content and/or user interface elements needed based on item-type (e.g., birthday posts may include an extra banner bar), render context (e.g., whether comments, action bar, buttons, etc., should be included/displayed), differences introduced due to componentization, predetermined sizing inputs, size dimension of embedded media, etc. In some implementations, the predetermined sizing inputs may be based on the content to be included in the content item (e.g., author name=70px, number of comments (e.g., 0, 1, 2, etc.). The predetermined sizing inputs may provide for a range of size dimensions depending on content, or an average size dimension. The height estimator 226 may calculate the size dimension(s) (e.g., height, width, etc.) of media (e.g., an embedded photo, video, map, etc., included in a post) based on media attributes (e.g., included in a header or associated metadata). In implementations where the height estimator 226 may be unable to calculate an estimated size dimension (e.g., height) for a content item (e.g., due to an error or for unrecognizable items), the height estimator 226 may defer to a predetermined default size dimension (e.g., height).

The multicolumn layout engine 228 may be configured to lay out the content items in 1, 2, . . . , N in adjacently situated containers (e.g., columns, rows) based on the viewport size (e.g., width of a browser window, width of the columns, etc.). While the present disclosure is largely described within the context of using column-based layouts, it could also apply to/cover row-based layouts having content items that are laid out in adjacently situated rows determined based at least on corresponding height measurements (e.g., height of the browser window, height of the rows, etc.), or to three-dimensional layouts that include both rows and columns. In some implementations, the multicolumn layout engine 228 may include an APIs for manipulating (adding, deleting, moving, etc.) the content items being arranged. For example, the multicolumn layout engine 228 may include an API for inserting a content item at a specific location (e.g., which can be driven by interface design requirements, for instance, fixing a particular content item at the top right or left corner, etc.). The layout generator 230 may use the APIs to direct the behavior of the multicolumn layout engine 228.

The multicolumn layout engine 228 may be configured to place the set of content items in the initial layout in order of rank (e.g., best to worst, highest to lowest, etc.). In some implementations, the multicolumn layout engine 228 may be configured to be deterministic (e.g., by the layout generator 230), meaning for a given set of content items and viewport, it will generate and return the substantially same layout, although other configurations are also contemplated and possible.

The multicolumn layout engine 228 may determine the maximum number of containers (e.g., columns) to support in the layout, and/or the style attributes (e.g., CSS classes) for the containers and content items (e.g., width, height, etc.), based on viewport size (e.g., browser size, window size, etc.). In some implementations, the viewport size may be determined using browser data 408. For instance, the browser data 408 may include a cookie (e.g., zwieback cookie) that specifies the last known viewport (e.g., browser window) size. If the multicolumn layout engine 228 is unable to determine the viewport size, the multicolumn layout engine 228 may defer to container and size defaults that are set based on the type of viewport being used (e.g., UserAgent); hardcoded (e.g., 2 column default at 440px); set based on user bandwidth; and/or other criteria, etc. In some implementations, the multicolumn layout engine 228 may receive layout information (e.g., number of columns currently being displayed, column widths, etc.), which the stream builder 222 may use to create the layout config 406. The multicolumn layout engine 228 may use this layout config 406 along with or in the place of the browser data 408.

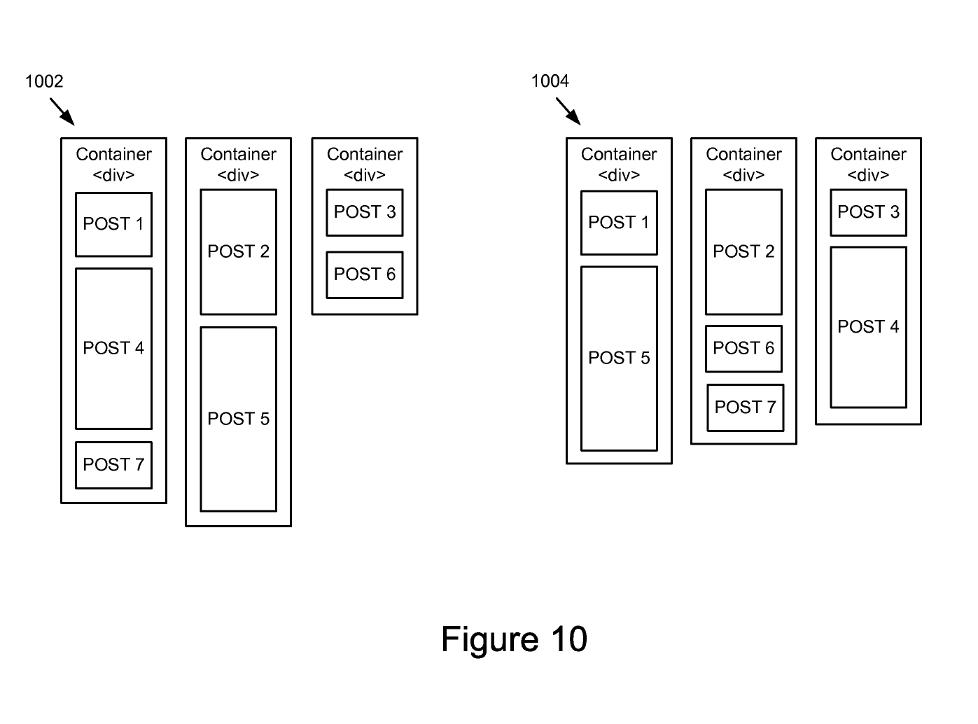

Content items may be placed in the columns of the initial layout by the multicolumn layout engine 228 using a predetermined order, including, for example, right to left (RTL) or left to right (LTR). For example but not limitation, FIG. 10 depicts a set of 7 layout objects (e.g., posts) placed LTR using three passes to populate a three column initial layout 1002. In some implementations, the multicolumn layout engine 228 may skip a column if it is not the next shortest column available based on its estimated height. For example but not limitation, when placing another content item (e.g., Post 8) into the example layout 1002, Post 8 would be placed in the right-most column by the multicolumn layout engine 228 because the right-most column is currently the shortest, e.g., the estimated height of the content items already included in the middle column (e.g., Post 2 and Post 5) exceeds the estimated height of the content items already included in the right-most column (e.g., Post 3 and Post 6).

The getactivities action module 220 may act as a controller to receive requests from and send responses to the front-end rendering engine 110. In some implementations, the getactivities action module 220 may receive a request from the stream loader 320 requesting any new content items (e.g., posts) that may be available be provided for loading into the user's content stream. In response, the stream builder 222, in cooperation with the other components of the back-end rendering engine 120, determine a set of content items, and an initial layout for the content items, and provide them to the abstract stream component 328 for further processing, optimization, and display by the front-end rendering engine 110.

On the front-end, to optimize the layout of the content items, the multicolumn layout engine 322 may determine the number of containers (e.g., columns) that should be displayed in the layout, may optimize the layout of the content items to substantially equalize the height of the containers in each array, may promote superposts, manage the container arrays between superposts so they have substantially similar dimensions (e.g., heights), may trigger the re-processing of the initial layout if a predetermined threshold has been met. The multicolumn layout engine 322 may be coupled to and configured to interact, directly or indirectly, with the stream loader 320, the abstract stream component 328, the responsive layout 324, and the card stretcher 326 to perform these acts.

The multicolumn layout engine 322 may make adjustments to the cards to substantially equalize the height of the containers that contain them. Adjustments may include swapping the positions of two or more cards (e.g., posts) in the layout and adjusting the size of the cards themselves. Non-limiting examples of adjustments can include: adding or subtracting padding or margin to pieces of content, subcomponents of pieces of content, and layout structures which contain pieces of content; modifying the dimensions of pieces of content, subcomponents of pieces of content, and layout structures which contain pieces of content; filling layout gaps with additional content; adding additional content within content pieces to increase size; etc. By way of further example and not limitation, the multicolumn layout engine 322 (in cooperation with the card stretcher 326 in some cases) may measure the sizes of rendered pieces of content and organize them in such a way that minimizes misalignment and gaps in a layout; identify the gaps created by misaligned content pieces in a layout and apply one or more different adjustments to some or all the pieces of content in the layout; rearrange two or more of the cards in the layout to more closely equalize the height of the containers (e.g., columns, rows) or other dimensions (e.g., x, y, z) of a container; process the rendered/actual sizes of the content items included in the containers and determine from the processing that two of the content items should swap places so the containers may be more closely aligned; etc. These collective adjustments, when applied over the entire layout, can allow for pieces of the layout to be organized and aligned in a visually processable way (e.g., see FIG. 9), and when the viewport is adjusted (e.g., upon receiving viewport size change events 404), or new content is loaded into the layout, the layout may be re-processed by the front-end rendering engine 120 and/or the back-end rendering engine 110 to make new adjustments.

To adjust the size of the content items themselves, the multicolumn layout engine 322 may interact with the card stretcher 326. The footprint of a content item within a layout is sometimes referred to herein as a card. In some implementations, the card stretcher 326 may adjust the size (e.g., height) of a given card by adding padding (e.g., along a top and/or bottom of the card), changing the size (e.g., height) of one or more of the elements of the card (enlarging text, adding line-spacing, adding padding, etc.), adding content to the content item (e.g., additional comments, buttons, images, text, etc.), etc. The card stretcher may be configured to adjust the size of the cards based on card-type. In some implementations, the multicolumn layout engine 322 may (substantially) equalize the overall height of all of the columns in the initial layout by making adjustments via the card stretcher 326 to one or more content items of the layout.

By way of further example and not limitation, a given card may be stretched by including additional padding (e.g., vertical or horizontal) to various elements (e.g., footer, header, between text content and an embedded object, etc.). For instance, vertical padding (e.g., 20-50px) padding between may be added between the text and embedded object of a content item. The stretchable aspects of a card may be pre-defined and updatable. In some implementations, the multicolumn layout engine 322 may apply the appropriate style attributes to the containers (e.g., column elements) and the cards/content items included therein may inherit the style attributes. The style attributes applied to the cards may be overridden so the size (e.g., height, width) of each card (e.g., post) may be adjusted. In some implementations, the card stretcher 326 used by the multicolumn layout engine 322 may be configured to apply additional styling (e.g., CSS classes, CSS attributes, etc.) to selectively stretch various aspects of the card (card width, card height, size of content within the card, embedded object width, embedded object height, etc.). Additionally or alternatively, the card stretcher 326 may supplement the content of the card/content item to increase its overall size (e.g., increase number of comments shown), as discussed further elsewhere herein.

The multicolumn layout engine 322 may be configured to set style properties, which may control the sizes (e.g., widths) of the adjacent containers (e.g., columns) of the layout. In some implementations, the multicolumn layout engine 322 may set the style properties by setting the appropriate width-setting CSS classes responsive to receiving a trigger event (e.g., browser size change). Non-limiting examples of trigger events may include a window resize, a page refresh, a timer, a time-out, authentication token expiration, etc. For example, the responsive layout 324 may provide a viewport size change event 404 to the multicolumn layout engine 322, and based on the viewport size change event 404, the multicolumn layout engine 322 may set the number of to display (e.g., by activating and or deactivating columns of the layout using corresponding CSS classes). In some implementations, the multicolumn layout engine 322 may be configured to determine whether the content rendered for display (e.g., the layout) substantially spans the entire viewable layout area, and if not, may trigger a re-determination of the layout by the back-end rendering engine 120. Further, the multicolumn layout engine 322 may be configured to trigger a re-determination of the layout when a trigger event (e.g., change in the browser size) exceeds an inflection point and/or threshold. This is advantageous because it can reduce the amount of processing/optimization that is performed on the front-end to reduce lag and provide users with a responsive user experience.

The multicolumn layout engine 322 may interact with the responsive layout 324 to register a listener that listens for these changes and can make adjustments and/or initiate a re-determination of the layout by the back-end rendering engine 120 if an inflection point is reached (e.g., the number of supported columns by a layout has been exceeded). The responsive layout 324 includes a framework for registering and listening to changes in named properties (e.g., browser size changes). For instance, the responsive layout 324 may include functionality for registering a property (e.g., dynamically calculate a property based on other dependent properties, e.g., CSS values); installing a trigger (e.g., register callbacks on property changes, e.g., add/remove class based on property); etc.

In some implementations, the multicolumn layout engine 322 may be configured to support a maximum height on certain stream items (e.g., posts, post types, etc.). For instance, a given content item may include metadata indicating the max/max height values, or the mix/max values for the content item may be predetermined (e.g., stored as variable, in cache, etc.). The multicolumn layout engine 322 may be configured to base placement of content items in the initial layout based on the min/max heights of the content items, and may set appropriate max height values based on height calculations of adjacent columns.

The multicolumn layout engine 322 may promote one or more superposts, which span multiple containers (e.g., columns) of the layout. For instance, the multicolumn layout engine 322 may promote a highly relevant content item that contains high resolution images as superposts at the top of a content stream within the viewport so it is prominently placed for viewing by the user. In implementations including multiple superposts within a content stream, the multicolumn layout engine 322 can ensure that column arrays between superposts are substantially aligned height-wise to provide a visual appealing overall layout to the users. In implementations that include a superpost, the layout response 420 may restart the indexing for each set of content items that come after a superpost.

The multicolumn layout engine 322 may be configured to support inserts for real-time updates. In some implementations, the stream loader 320 may signal the getactivities action module 220 for new updates, and in response, the back-end rendering engine 120 may process any new stream content items (e.g., posts) and the getactivities action module 220 may then provide the new stream content items to the abstract stream component 328 for layout processing and loading into the user's content stream. In some implementations, the getactivities action module 220 may, independently from the stream loader 320, push new stream content items to the abstract stream component 328 for layout processing and loading into the user's content stream. Further implementations are also possible and contemplated including, for example, where the stream loader 320 and the abstract stream component 328 are integrated into a single component configured to perform the above-noted acts and/or functionality.

To generate and optimize a layout, the multicolumn layout engine 228 and the multicolumn layout engine 322 may both model the layout by building tree structure representations of the layout. For example, on the back-end, the multicolumn layout engine 228 may build a tree structure using template chunks for the nodes (e.g., posts) and on the front-end, the multicolumn layout engine 322 may build a DOM-based tree structure for rendering and optimizing the layout. Both tree structure variations may support manipulation of the layout via operations including, but not limited to, adds, deletes, and inserts of nodes, etc. The various other components of the back-end rendering engine 120 and the front-end rendering engine 110 may interact with the layout engines 228 and 322, respectively, (e.g., via APIs) to manipulate and/or retrieve information about the nodes, set layout parameters (e.g., max number of columns, promote superposts, etc.).

By way of further example, the internal tree structure built by the multicolumn layout engine 322 may include a representative node for each of content items to be included in the content stream. For example, the tree structure may include an internal HTML Document Object Model (DOM) (e.g., internal DOM 314) that can be manipulated to modify (e.g., move, delete, add, etc.) nodes included therein. The multicolumn layout engine 322 may export the DOM nodes for the items of the layout object 424 in a logical order. The multicolumn layout engine 322 may be coupled to and interact with the abstract stream component 328 to receive the layout object 424. By way of further example, the tree structure may include nodes for a main container <div> element that identifies the layout space and an array of child nodes for the columns container <div> elements. Superposts may be included as <div> elements that separate the array of child nodes (e.g., to separate upper and lower column arrays). In some implementations, this tree structure may be generated based on the set of content items, the layout object 424, and/or the layout response 420, which includes an initial representation of the layout, received from the back-end rendering engine 120.

In some implementations, to set the width of the containers (e.g., columns) in the layout, the multicolumn layout engines 228 and/or 322 may generate style-sheet information, including, for example and not limitation, CSS classes for column container elements (e.g., <div> elements). In some implementations, CSS classes for each possible column width may be defined in one common location so it is easily accessible by the front-end rendering engine 110 and/or client application 108. This style information may dictate the width of each card added to the column(s) including, for example and not limitation, the card's gutters, the card's dimensions of the card's, the card's embedded content, etc. Further, how to handle any changes in an aspect of a card/content item (e.g. additional content showing more participants in a conversation) may be defined in the style sheet information (e.g., GSS) for the card.

In some implementations, the layout processing performed by the multicolumn layout engine 322 and/or 228 may consider user gazing patterns and the higher ranked areas may be placed in areas users tend to look first when consuming their stream contents. For instance, users may scan a page in a downward pattern that includes a LTR gazing motion for a first row and RTL gazing motion for the second “row” of content, and which is repeated on down the page. Additionally or alternatively, users may prefer hot “corners”, which may include the top left, top right, and bottom right of the page. In some cases, a heavy user may tend to scan left-to-right, but may be drawn toward the content in the right corner and on the right side. When rendering layouts, the layout engines 322 and/or 228 may place higher ranked content items in these more frequently viewed areas to provide a user with a more satisfying experience. In some implementations, a user may see 4 content items per page in 2 column layouts and 6 content items per page for 3 column layouts, although other arrangements are also possible and contemplated.

Additional and/or alternative features and structure of the system 100 may include: popping between multiple card widths for multi-column layouts based on browser width; allowing certain areas within cards to be vertically elastic to take up whitespace (e.g., padding above the main content, number of lines of original text shown (for truncated content items), height of comments panel & number of comments shown); retaining non-elastic padding/margins outside cards to retain uniform spacing; setting a number of columns based on user agent (e.g., 1 for tablet, 2 for desktop, 2 for unknown, etc.) unless more specific size browser size information is available for the user; placing content items out of logical/ranked order to fit the layout and maximize visual effectiveness of the stream; fixing placement of various content items in stream which must appear in predetermined locations in each type of layout (e.g., share box, a mixin); continuing support for a right hand sidebar and/or content by reducing the stream area to N−1 columns where N=number of columns that would be shown without a right hand sidebar; supporting a chat roster (e.g., pinned panel once the window reaches a certain width); providing for soft stream stability (e.g., given the same content and the same browser size, the number of columns, superposts, etc., of the layout should be the same); rendering the stream in logical order for web crawlers; supporting keyboard and ally use cases (e.g., for keyboard navigation, the “next” content item can be defined as the one whose top edge is the next highest, regardless of column); preventing snapping of the stream after initial render (e.g., layout presented before further user interaction); providing support for caching; providing support server-side rendering; supporting new content item widths, different column restrictions, and different requirements for different services provided by the application engine 122; and balancing initial image downloads between bandwidth and resolution.

While FIG. 4 depicts various components as being distinct, it should be understood that one or more of these components may be combined, reorganized, or further segregated without departing from the scope of this disclosure. For instance, in various implementations, structure, acts, and/or functionality described with respect to the front-end rendering engine 110 may be incorporated into the back-end rendering engine 120, or vice versa. Further, in various implementations, one or more of the components (or their structure, acts, and/or functionality) of the front-end rendering engine 110 and/or the back-end rendering engine 120 may be combined together or further divided into additional components.

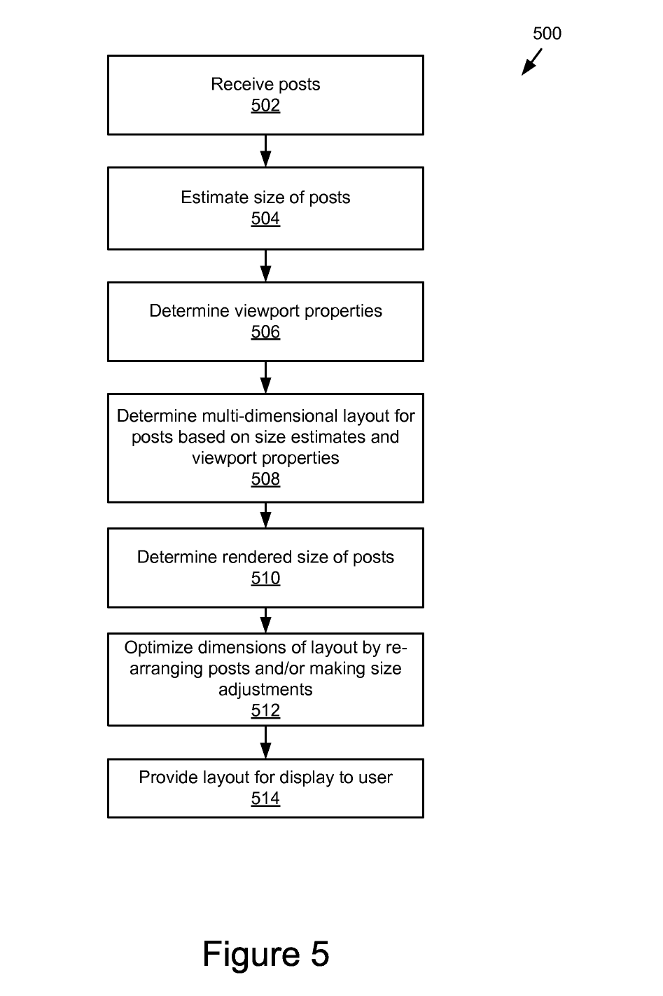

FIG. 5 is a flowchart of an example method 500 for automatically determining and optimizing a multi-dimensional layout. In the method 500, the stream builder 222 may receive 502 a set of content items (e.g., posts) and cooperate with the height estimator 226 to estimate 504 the size of the posts. For example, each post may take up a certain footprint (also referred to herein at times as a card) when placed in a container (e.g., column) of the layout. In some implementations, the height estimator 226 may estimate the height of each card/post based on the width of the container (e.g., column) in which the card/post will be placed, the content included in the post, the type of posts, etc., as discussed elsewhere herein.

Next, the multicolumn layout engine 228 may determine 506 the properties of the viewport that requested the set of posts and may determine 508 a multidimensional layout for the set of posts based on the corresponding card-size estimates and the viewport properties. In some implementations, the multicolumn layout engine 228 may determine a flexible layout that accounts for possible further changes in the size of the viewport. For example, the multi-dimensional layout determined by the layout engine 228 may include single column, two column, three column, etc., layout options that include corresponding stylesheet information. The front-end rendering engine 110 may activate a particular layout option (e.g., two column, three column, etc.) by implementing different style information (e.g., CSS classes) depending on which layout option is needed for a particular viewport size.

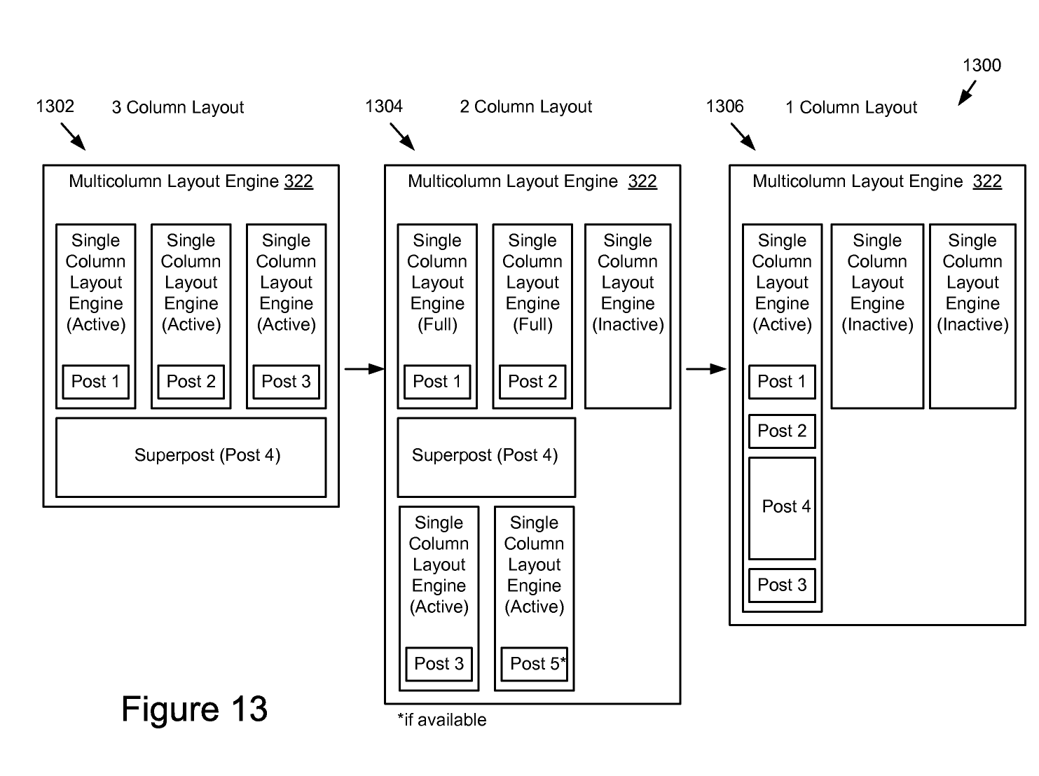

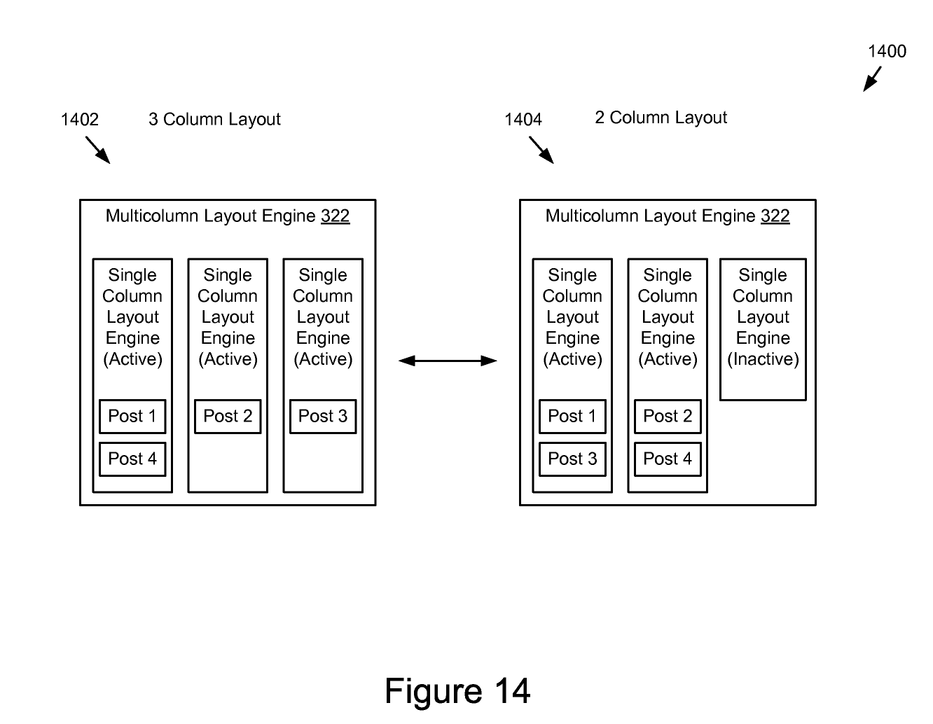

By way of further example and not limitation, FIGS. 13 and 14 are diagrams illustrating the flexibility of the multicolumn layout engine 322 to selectively determine layout parameters and content arrangement based on viewport size. In particular, FIG. 13 depicts an example progression 1300 showing how the multicolumn layout engine 322 may conveniently change the layout from a three column layout 1302 to a two column layout 1304 or further to a one column layout 1306 (e.g., by applying the corresponding stylesheet information). FIG. 14 depicts another example progression 1400 showing a change from a three column layout 1402 to a two column layout 1404. The example progressions 1300 and 1400 show how the cards can be rearranged within the columns that are active. For instance, with reference to example layouts 1402 and 1404, 1402 has posts 1-4 distributed RTL over three active columns where 1404 has posts 1-4 distributed RTL over two active columns.

Referring back to FIG. 5, once the initial multi-dimensional layout for the set of posts has been determined, the multicolumn layout engine 322 may then determine 510 the rendered size of the posts, optimize 512 the dimensions of the initial layout, and then provide 514 the layout for display to the user (e.g., in cooperation with the client application 108). In some implementations, the multicolumn layout engine 322 may optimize the dimensions of the initial layout by swapping the positions of two or more cards/posts included in layout and/or making size adjustments to the cards/posts. The multicolumn layout engine 322 may perform this optimization to substantially equalize the height of each of the columns in the layout, which makes the layout of the set of posts appear consistent and visually appealing to the user. Additionally and/or alternatively, the multicolumn layout engine 322 may perform this optimization to create space for placing/promoting superposts (e.g., posts that span across multiple column widths).

By way of further example and not limitation, FIG. 9 is a diagram illustrating the optimization of an example initial layout 902. As depicted, the multicolumn layout engine 322 may receive the initial layout 902 (as rendered and provided by the back-end rendering engine 120) may determine the actual height of the columns as well as the cards included in the columns (e.g., based on the height information for the corresponding elements (e.g., <div>s) included in the DOM). Using this information, the multicolumn layout engine 322 may compare the height of the columns and determine whether any gaps exist along a lower boundary. In some implementations, since the initial layout 902 may be based upon height estimates calculated by the height estimator 226, the actual heights determined when rendering the posts for display may differ from the estimated heights, and the columns of the layout may actually have sizes than were initially determined by the multicolumn layout engine 228.

To fill in the gaps, the multicolumn layout engine 322 may re-distribute two or more of the posts within the layout. For example, in layout 904, post 1 has been moved to the location formerly occupied by post 5, post 5 has been moved to the location formerly occupied by post 6, and post 6 has been moved to the location formerly occupied by post 1. To make size adjustments, the multicolumn layout engine 322 may cooperate with the card stretcher 326 to adjust the size of a card by modifying one or more aspects of the card. For instance, the card stretcher 326 may supplement the content of the posts or add padding to the posts to adjust the overall height of the posts. As a further example, in layout 906, posts 6, 4, 7, 5, and 9 have been stretched by the card stretcher 326 by adding content (e.g., additional comments, interactive elements, related content, etc.) and/or padding to the footer of the cards/posts. In some implementations, the multicolumn layout engine 322 may build an internal version of the DOM (e.g., the internal DOM 314) and the card stretcher 326 may manipulate it (e.g., move nodes, add nodes, remove nodes, modify nodes, etc.) using APIs exposed by the multicolumn layout engine 322. Once manipulation of the internal version of the DOM 314 is complete, the multicolumn layout engine 322 may push the changes to the DOM 314 of the client application 108 so the changes (e.g., optimized layout) may be displayed to the user.

Similarly, FIG. 10 is a diagram illustrating the rearrangement of posts of an example initial layout by the multicolumn layout engine 322. As with FIG. 9, the multicolumn layout engine 322 may reorder the posts of initial layout 1002 into the optimized layout 1004 by moving posts 4-7 into different containers (e.g., <div>s) of layout, and thereby adjust the heights of the adjacent containers to be substantially more equivalent in height. The multicolumn layout engine 322 may further cooperate with the card stretcher 326 to finalize height adjustments (by adjusting the size of one or more cards in the second and third columns) of the columns so they appear to a human user to have the same height. In some implementations, the columns may have the same or substantially the same height (e.g., within 0-5%) as measured in pixels.

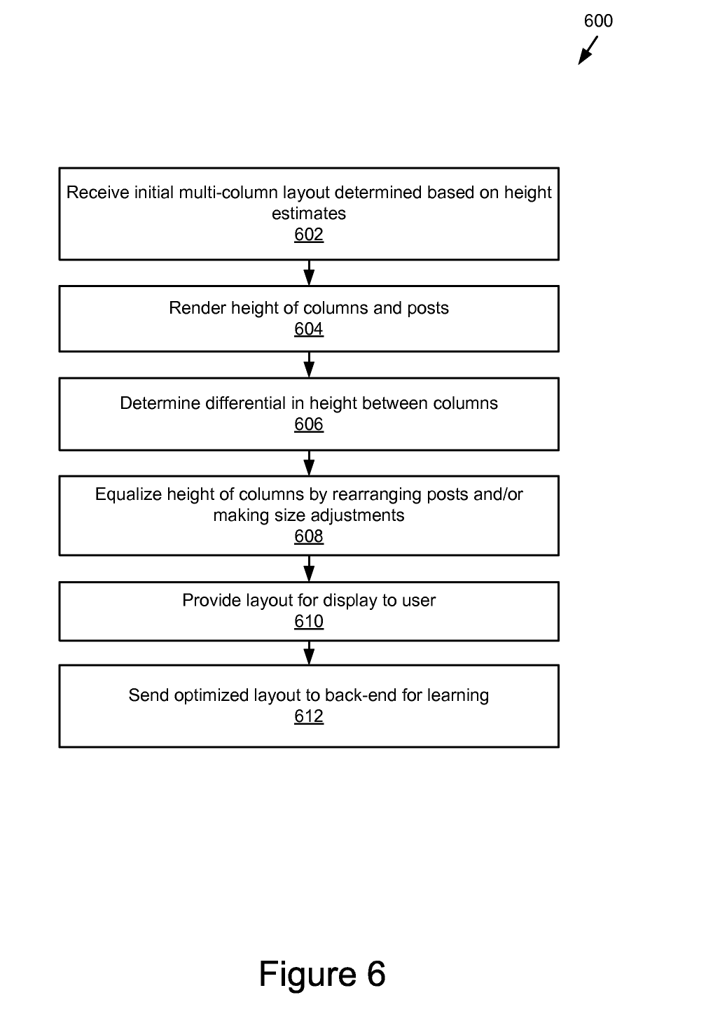

FIG. 6 is a flowchart of an example front-end method 600 for optimizing an example predetermined initial layout. In block 602 of the method 600, the multicolumn layout engine 322 may receive an initial multicolumn layout from the back-end rendering engine 120. The initial multicolumn layout may be determined by the back-end multicolumn layout engine 228 using height estimates calculated by the height estimator 226. Next, the multicolumn layout engine 322 may render 604 the height of the columns and content items (e.g., posts) and determine 606 a differential in height between the columns, as discussed elsewhere herein. The multicolumn layout engine 322 may then optimize the layout. For instance, the multicolumn layout engine 322 may equalize 608 the height of the columns by rearranging posts and/or making size adjustments. In some implementations, the multicolumn layout engine 322 may calculate various scenarios of placement of the posts within the columns to determine the most optimal arrangement of the posts. Once an optimal layout has been determined and provided 610 to user for display by the multicolumn layout engine 322, the engine 322 may send 612 the optimized layout to the back-end for learning. For example, the layout generator 230 may receive the optimized layout and/or the current state of the DOM and compare it to the initial layout to determine which changes were made. Using the comparisons over several iterations, the layout generator 230 may identify common adjustments that were made by the front-end rendering engine 110 and may adapt the algorithm used by the layout generator 230 and/or the multicolumn layout engine 228 to improve the initial layouts determined by them in future.

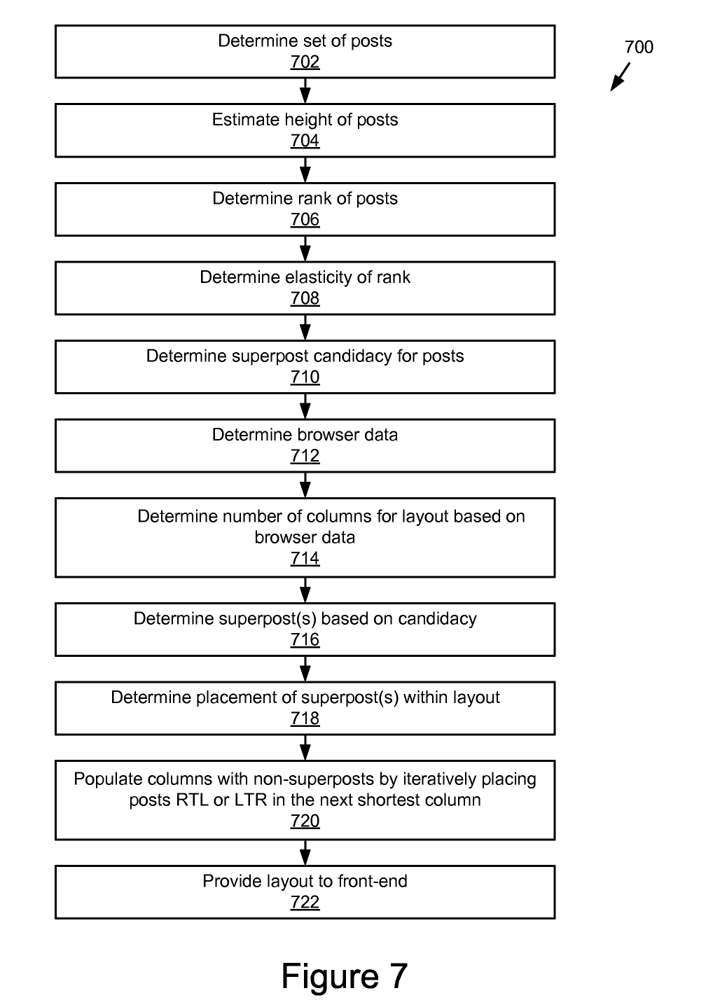

FIG. 7 is a flowchart of an example back-end method 700 for determining an initial layout. In block 702, the stream builder 222 may determine a set of content items (e.g., posts). In some implementations, the stream builder 222 may interact with the application engine 122 to determine the set of posts. For example, the application engine 122 may be a social network application and may provide the stream builder 222 with a set of posts. Next, in block 704, 706, 708, 710, and 712, the stream builder 222 may determine, in cooperation with other components, estimated heights for the posts, ranks for the posts, elasticity measures for the ranks, and superpost candidacy bits for the posts. In some implementations, the stream builder 222 may determine the ranks, elasticities, and candidacy bits by receiving information from the application engine 122 in the form of metadata. Further, the stream builder 222 may determine the height of the posts by receiving height estimates from the height estimator 226. In some implementations, the stream builder 222 may provide various information to the height estimator 226 for it to use when determining the height estimates, as discussed further elsewhere herein.

The multicolumn layout engine 228 may then proceed to determine 712 browser data for the user designated to receive the set of posts and determine 714 the number of columns for the initial layout, as well as the number of column options supported by the initial layout, based on the browser data. In some implementations, the browser data may include the user's bandwidth, viewport size, etc., which the multicolumn layout engine 228 may use to determine how many columns to include in the layout, and whether to compute multiple column options for the layout. For example, for a user who has narrow bandwidth and would likely be required to wait a long time to receive page including multiple columns and heavy content and formatting, the multicolumn layout engine 228 may determine the initial layout to have a more simplistic format to reduce the size of the data transferred to the client device 106 of that user. In another example, for a user who has sufficient bandwidth, the multicolumn layout engine 228 may then determine the number of columns and column options to include in the layout based on the viewport size, as discussed elsewhere herein. In some implementations, a user may set a preference to receive a low-bandwidth version of the layout.

Next, the layout generator 230 may determine 716 which posts (if any) should be promoted as superposts based on candidacy bits and may determine 718 their placement within the initial layout (e.g., in cooperation with the multicolumn layout engine 228). In some implementations, the front-end multicolumn layout engine 322 may override the superposts promoted by the layout generator 230. For example but not limitation, if the user resizes the window he or she is using to view his or her content stream, the multicolumn layout engine 322 may switch the layout from a three column layout to a one column layout. Further, the multicolumn layout engine 322 may not elect to promote a superpost because of its proximity to an adjacent superpost. For instance, a rule may be defined that requires superposts to be spaced a certain distance apart or have a predetermined amount of content that separates them, and a multi column layout engine 322 may override placement of the superposts based on the rule. As another non-limiting example, the layout object 424 may include metadata having a repulsion indicator for two or more of posts that indicates how closely they can be placed within a given layout, and the multicolumn layout engine 322 may optimize the layout/place the posts in accordance with the repulsion indicator.

Continuing on, in block 720, the multicolumn layout engine 228 may populate 720 the columns of the layout with the non-superpost posts by iteratively placing the posts RTL or LTR in the next shortest column, and then may provide 722 the initial layout to the front-end for further rendering.

By way of the further example, FIG. 16 is a graphic representation of an example user interface 1600 containing a content stream 1602 having an optimized layout of posts. The content stream 1602 includes an example of a superpost 1608 that spans all of the columns of the content stream 1602. The superpost 1608 divides the layout into two column arrays 1606 and 1610. Each column array 1606 and 1610 may be laid-out and optimized by the system 100 as discussed in further detail elsewhere herein, so that the posts may appear to the user as consistently spaced and placed in columns of equal height. In some implementations, one or more of posts (e.g., post 1604) may be fixed placement posts that are always placed in the same locations of the layouts by the system 100.

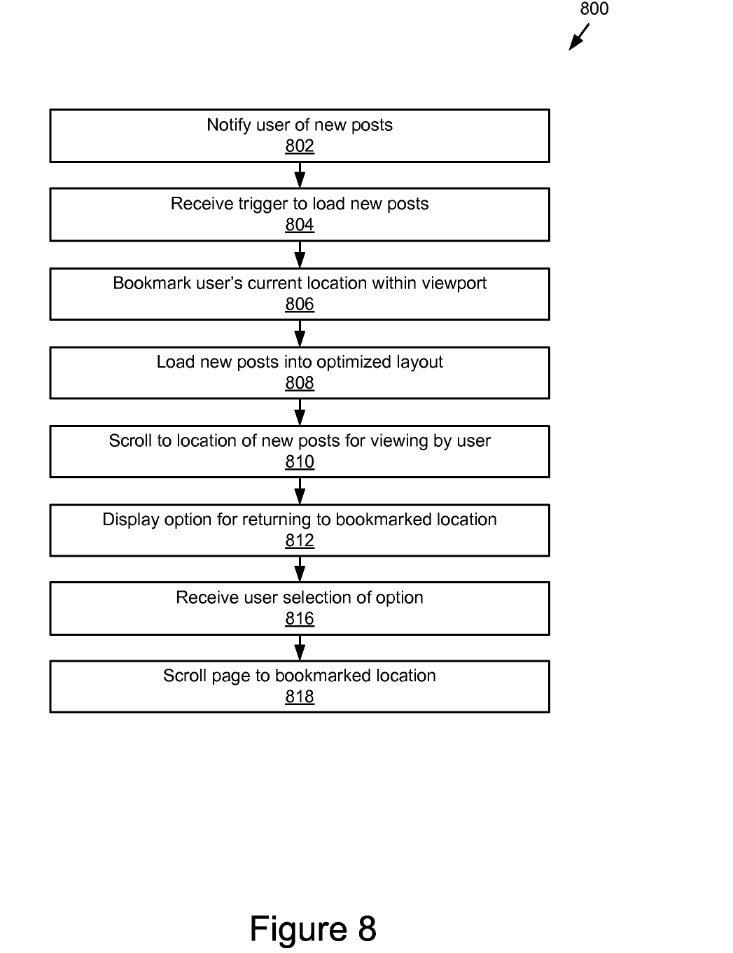

FIG. 8 is a flowchart of an example method 800 for loading new content items (e.g., posts) into a content stream. In block 802, the abstract stream component 328 may notify the user that new posts are available for viewing, and in response, may receive 804 a trigger to load the new posts. Prior to loading the new posts, the abstract stream component 328 may send a signal to the bookmark module 330 to bookmark 806 the user's current location within the viewport. The abstract stream component 328 may then enable the loading 808 of the new posts into the layout. In some implementations, the abstract stream component 328 may receive notification of the new posts from the getactivities action module 220 as discussed elsewhere herein and may then cooperate with the multicolumn layout engine 322 to optimize a layout for the posts. In some implementations, the new posts may be placed into nearly equally sized columns using the functionality discussed elsewhere herein. Next, the bookmark module 330 may scroll 810 to the location of the newly loaded posts so the user can view them. In some implementations, the new posts may be loaded at the top of user's content stream. The bookmark module 330 may then display 812 an option for returning the user to the bookmarked location to continue where the user left off before the new posts were loaded. In response, the bookmark module 330 may receive 816 a user selection of the option and then scroll 818 the page to the bookmarked location.

By way of the further example, FIGS. 15A and 15B are graphic representations of an example user interface 1500 for viewing new content items (e.g., posts) loaded real-time into a content stream 1502. The content stream 1520 includes an example of a superpost 1504 that spans all of the columns of the content stream 1502. As depicted, the user interface 1500 may include button 1506 for loading the new posts into the user's content stream 1502. Selection of this button 1506 may scroll to the top of the content stream 1502 as depicted in FIG. 15B where the new posts are inserted (e.g., RTL or LTR, etc.) and/or adjusted. Further, with reference to FIG. 15B, the user interface 1500 may include a bookmark button 1514 that is selectable by the user to return to the location he or she was at prior to being scrolled to the top of the content stream 1502. The posts shown in FIG. 15B are examples of new posts that were inserted into the content stream 1502.

It should be understood that the format of the user interfaces, content streams, buttons, layouts, posts, and other elements that are shown in FIGS. 9-16 are provided by way of example, and that the information and elements displayed in these user interfaces are not limited to any specific type or size, and that other variations are contemplated. For instance, user interfaces that are compatible with smaller screen sizes like those included in various handheld mobile devices (e.g., mobile phones) may be generated. Moreover, the layouts and user interfaces rendered by the system 100 may have a variety of distinct formats, content, and positions within the window, and combinations, all of which are encompassed by the scope of the present disclosure.

Technology including automatically aligning a multi-dimensional layout is described. In the above description, for purposes of explanation, numerous specific details are set forth in order to provide a thorough understanding of this disclosure. It should be understood, however, that the systems, methods, and computer products described herein can be practiced without these specific details. In other instances, structures and devices are shown in block diagram form in order to avoid obscuring the disclosure. For example, the various components, operations, and/or features are described in some implementations above with reference to user interfaces and particular hardware. However, the present disclosure applies to any type of computing device that can receive data and commands, and any peripheral devices providing services.

Reference in the disclosure to “one implementation,” “an implementation,” “some implementations,” etc., means that a particular feature, structure, or characteristic described in connection with the implementation is included in at least one implementation. The appearances of the phrase “in one implementation” or “in some implementations” in various places in the disclosure are not necessarily all referring to the same implementation(s).

Some portions of the detailed descriptions above are presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms including, for example, “processing” or “computing” or “calculating” or “defining” or “identifying” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, for example, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosure can take the form of an entirely hardware implementation, an entirely software implementation or an implementation containing both hardware and software elements. In a preferred implementation, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description above. In addition, the present disclosure is not described with reference to any particular programming language. It will be appreciated that a variety of programming languages may be used to implement the teachings of the disclosure as described herein.

The foregoing description of the implementations of the present disclosure has been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, it should be understood that the routines, features, attributes, methodologies and other aspects of the present disclosure can be implemented as software, hardware, firmware or any combination of the three. Also, wherever a component, an example of which is a module, of the present disclosure is implemented as software, the component can be implemented as a standalone program, as part of a larger program, as a plurality of separate programs, as a statically or dynamically linked library, as a kernel loadable module, as a device driver, and/or in every and any other way. Additionally, the present disclosure is in no way limited to implementation in any specific programming language, or for any specific operating system or environment. Accordingly, the present disclosure is intended to be illustrative, but not limiting, of the subject matter set forth in the following claims.

What is claimed is:

1. A computer-implemented method comprising:
determining a plurality of content items for a content stream;
estimating size dimensions for the content items;
determining a multidimensional layout for the content items that places the content items into two or more adjacent containers based on the size dimensions;
determining a difference in size between the two or more adjacent containers; and
adjusting an aspect of one or more of the content items to substantially equalize a size of the two or more containers.

2. The computer-implemented method of claim 1, wherein adjusting the aspect of the one or of more of the content items includes exchanging two or more of the content items between the two or more adjacent containers.

3. The computer-implemented method of claim 2, wherein exchanging two or more of the content items between the two or more adjacent containers includes determining that a rank elasticity measurement for each of the two or more content items meets a predetermined threshold.

4. The computer-implemented method of claim 3, wherein adjusting the aspect of the one or of more of the content items includes adjusting a height of the one or more of the content items.

5. The computer-implemented method of claim 1, further comprising:
determining a viewport property for a viewport designated to display the plurality of content items in the content stream; and
determining a number of columns for the multidimensional layout based on the viewport property, wherein each of the two or more adjacent containers represents a column of the multidimensional layout.

6. The computer-implemented method of claim 1, further comprising:
rendering the two or more adjacent containers; and
determining a height for each of the two or more adjacent containers based on the rendering, wherein each of the two or more adjacent containers represents a column of the multidimensional layout and the determining the difference in size between the two or more adjacent containers includes comparing the height of each of the two or more adjacent containers.

7. The computer-implemented method of claim 1, further comprising:
processing an optimized layout to improve placement of a future plurality of content items in a future multidimensional layout.

8. A computer program product comprising a computer usable medium including a computer readable program, wherein the computer readable program when executed on a computer causes the computer to:
determine a plurality of content items for a content stream;
estimate size dimensions for the content items;
determine a multidimensional layout by placing the content items into two or more adjacent containers based on the size dimensions;
determine a difference in size between the two or more adjacent containers; and
adjust an aspect of one or more of the content items to substantially equalize a size of the two or more containers.

9. The computer program product of claim 8, wherein to adjust the aspect of the one or of more of the content items includes exchanging two or more of the content items between the two or more adjacent containers.

10. The computer program product of claim 9, wherein exchanging two or more of the content items between the two or more adjacent containers includes determining that a rank elasticity measurement for each of the two or more content items meets a predetermined threshold.

11. The computer program product of claim 10, wherein to adjust the aspect of the one or of more of the content items includes adjusting a height of the one or more of the content items.

12. The computer program product of claim 8, wherein the computer readable program when executed on the computer further causes the computer to:
determine a viewport property for a viewport designated to display the plurality of content items in the content stream; and
determine a number of columns for the multidimensional layout based on the viewport property, wherein each of the two or more adjacent containers represents a column of the multidimensional layout.

13. The computer program product of claim 8, wherein the computer readable program when executed on the computer further causes the computer to:
render the two or more adjacent containers; and
determine a height for each of the two or more adjacent containers based on a rendering, wherein each of the two or more adjacent containers represents a column of the multidimensional layout and the determining the difference in size between the two or more adjacent containers includes comparing the height of each of the two or more adjacent containers.

14. The computer program product of claim 8, wherein the computer readable program when executed on the computer further causes the computer to:
process an optimized layout to improve placement of a future plurality of content items in a future multidimensional layout.

15. A system comprising:
a processor; and
a memory storing instructions that, when executed, cause the system to:
determine a plurality of content items for a content stream;
estimate size dimensions for the content items;
determine a multidimensional layout by placing the content items into two or more adjacent containers based on the size dimensions;
determine a difference in size between the two or more adjacent containers; and
adjust an aspect of one or more of the content items to substantially equalize a size of the two or more containers.

16. The system of claim 15, wherein to adjust the aspect of the one or of more of the content items includes exchanging two or more of the content items between the two or more adjacent containers.

17. The system of claim 16, wherein exchanging two or more of the content items between the two or more adjacent containers includes determining that a rank elasticity measurement for each of the two or more content items meets a predetermined threshold.

18. The system of claim 17, wherein to adjust the aspect of the one or of more of the content items includes adjusting a height of the one or more of the content items.

19. The system of claim 15, wherein the instructions, when executed, further cause the system to:
determine a viewport property for a viewport designated to display the plurality of content items in the content stream; and
determine a number of columns for the multidimensional layout based on the viewport property, wherein each of the two or more adjacent containers represents a column of the multidimensional layout.

20. The system of claim 15, wherein the instructions, when executed, further cause the system to:
render the two or more adjacent containers; and
determine a height for each of the two or more adjacent containers based on a rendering, wherein each of the two or more adjacent containers represents a column of the multidimensional layout and the determining the difference in size between the two or more adjacent containers includes comparing the height of each of the two or more adjacent containers.

21. The system of claim 15, wherein the instructions, when executed, further cause the system to:
process an optimized layout to improve placement of a future plurality of content items in a future multidimensional layout.
